(19) United States
(12) Patent Application Publication
(10) Pub. No.: US 2005/0244578 A1
(43) Pub. Date: Nov. 3, 2005

(54) System and method for field coating

(75) Inventors: Jan Van Egmond, Valkenburg (NL); Cornelis Van Zandwijk, Waddinxveen (NL)

Correspondence Address: HAYNES AND BOONE, LLP, 901 MAIN STREET, SUITE 3100, DALLAS, TX, 75202, US

(73) Assignee: Heerema Marine Contractors Nederland B.V., Leiden (NL)

(21) Appl. No.: 10/833,681

(22) Filed: Apr. 28, 2004

(51) Int. Cl. B05D 3/00

(52) U.S. Cl. 427/230; 427/300; 118/70; 118/665

(57) ABSTRACT

A field coating system comprises a chassis and a plurality of modules coupled to the chassis.

### BACKGROUND

The disclosures herein relate generally to deep water pipeline construction and more particularly to a system and method for field coating a pipeline.

Pipeline sections constructed into a pipeline are usually provided with a coating. As the quality of a weld to connect two sections of pipeline together does not tolerate the presence of coating material near the weld, the coating is cut back over some distance of the pipeline section ends in preparation for the weld. After completion of the weld, the welded portion connecting the pipeline sections must be coated before the pipeline may enter the water. This process is referred to as field coating. The area to be coated is typically the portion of the pipeline around the weld, however, it may be any interruption of the coating existing along the pipeline.

The field coating process involves cleaning the zone to be coated, preparing the surface of the zone to be coated, and coating the zone to be coated. The field coating process often exists in the critical path of pipeline construction, meaning that it is one of the sequence of activities that keeps the pipeline from being constructed faster. Present methods involve many steps which include multiple attachments and removals of equipment that slow the process down.

Accordingly, it would be desirable to provide a system and method for field coating absent the disadvantages found in the prior methods discussed above.

### SUMMARY

According to one aspect of the present invention, a field coating system is provided that includes a chassis and a plurality of modules coupled to the chassis. The plurality of modules are operable to perform a field coating process and define a channel for allowing an entity to move axially through the system, the movement being relative to the system, in order to apply a field coating to the entity.

According to another aspect of the present invention, a field coating system is provided that includes a chassis. A cleaning module is coupled to the chassis and operable to clean the entity as it travels through the system, the cleaning module defining a channel for allowing an entity to move axially through the cleaning module, the movement being relative to the cleaning module. A coating preparation module is coupled to the chassis and operable to prepare the entity for coating as it travels through the system, the coating preparation module defining a channel for allowing an entity to move axially through the coating preparation module, the movement being relative to the coating preparation module. A coating module is coupled to the chassis and operable to coat the entity as it travels through the system, the coating module defining a channel for allowing an entity to move axially through the coating module, the movement being relative to the coating module.

According to another aspect of the present invention, a pipelay vessel is provided that includes a construction ramp, the ramp operable to construct pipelines, mounted to the vessel. At least one working station including a chassis is coupled to the vessel, with a plurality of modules coupled to the chassis. The plurality of modules are operable to perform a field coating process and define a channel for allowing a pipeline to move axially through the system, the movement being relative to the system, in order to apply a field coating to the pipeline.

According to another aspect of the present invention, a method for applying a field coating is provided that includes providing a chassis, coupling a plurality of modules to the chassis which define a channel and are operable to perform a field coating process, moving an entity axially through the channel relative to the chassis, and performing the field coating process on the entity as it travels through the channel.

According to another aspect of the present invention, a method for field coating a pipeline is provided that includes providing a pipelay vessel, mounting at least one working station, the station including a chassis and defining a channel, to the vessel, coupling a plurality of modules to the chassis which are operable to perform a field coating process, moving an pipeline axially through the channel relative to the chassis, and performing the field coating process on the pipeline as it travels through the channel.

According to another aspect of the present invention, a field coating system is provided that includes a chassis. A means for allowing an entity to move axially through the system, the movement being relative to the system, is coupled to the chassis. A means for preparing the entity for coating as it travels through the system is coupled to the chassis. A means for coating the entity as it travels through the system is coupled to the chassis.

According to another aspect of the present invention, a field coating system is provided that includes a chassis. A cleaning module is coupled to the chassis and operable to clean the entity as it travels through the system, the cleaning module defining a channel for allowing an entity to move axially through the cleaning module, the movement being relative to the cleaning module. A first sensor is coupled to the cleaning module and operable to determine the cleanliness of the entity. A second sensor is coupled to the cleaning module and operable to activate and deactivate the cleaning module depending on the position of the entity in the system. A coating preparation module is coupled to the chassis and operable to prepare the entity for coating as it travels through the system, the coating preparation module defining a channel for allowing an entity to move axially through the coating preparation module, the movement being relative to the coating preparation module. A third sensor coupled to the coating preparation module and operable to determine whether the entity has been properly prepared for coating. A fourth sensor is coupled to the coating preparation module and operable to activate and deactivate the coating preparation module depending on the position of the entity in the system. A coating module is coupled to the chassis and operable to coat the entity as it travels through the system, the coating module defining a channel for allowing an entity to move axially through the coating module, the movement being relative to the coating module. A fifth sensor is coupled to the coating module and operable to determine the quality of the coating applied to the entity. A sixth sensor is coupled to the coating module and operable to activate and deactivate the coating module depending on the position of the entity in the system.

According to another aspect of the present invention, a field coating system is provided that includes a chassis. A coating preparation module is coupled to the chassis, the coating preparation module including a first housing, the first housing defining a channel for allowing the entity to move axially through the coating preparation module, the movement being relative to the coating preparation module, at least one section on the first housing moveably mounted to the first housing on hinges, a coating preparation apparatus with coating preparation elements situated within the first housing and operable to prepare an entity for coating as it travels through the system, at least one section on the coating preparation apparatus moveably mounted to the coating preparation apparatus on hinges, a first sensor situated within the first housing operable to determine whether the entity is prepared for coating, a second sensor situated within the first housing operable to activate and deactivate the coating preparation module depending on the position of the entity in the system, and a plurality of seals mounted to the first housing operable to seal and isolate a portion of the entity in the first housing. A coating module is coupled to the chassis, the coating module including a second housing, the second housing defining a channel for allowing an entity to move axially through the coating module, the movement being relative to the coating module, at least one section on the second housing moveably mounted to the second housing on hinges, a coating apparatus with coating elements situated within the second housing and operable to coat the entity as it travels through the system, at least one section on the coating apparatus moveably mounted to the coating apparatus on hinges, a third sensor situated within the second housing operable to determine the quality of the coating applied to the entity, a fourth sensor situated within the second housing operable to activate and deactivate the coating module depending on the position of the entity in the system, and a plurality of seals mounted to the second housing for sealing and isolating a portion of the entity in the second housing.

According to another aspect of the present invention, a method for field coating a pipeline is provided that includes providing a pipeline, the pipeline including a weld zone, providing a field coating system, the system including a coating preparation module and a coating module, moving the weld zone axially through the system, detecting the weld zone entering the coating preparation module, activating the coating preparation module, detecting the weld zone exiting the coating preparation module, deactivating the coating preparation module, determining the weld zone is prepared for coating, detecting the weld zone entering the coating module, activating the coating module, detecting the weld zone exiting the coating module, deactivating the coating module, and determining the weld zone is coated.

According to another aspect of the present invention, a field coating system is provided that includes a chassis. A cleaning module is coupled to the chassis, the cleaning module including a first housing, the first housing defining a channel for allowing the entity to move axially through the cleaning module, the movement being relative to the cleaning module, at least one section on the first housing moveably mounted to the first housing on hinges, a cleaning apparatus with cleaning elements situated within the first housing and operable to clean an entity as it travels through the system, at least one section on the cleaning apparatus moveably mounted to the cleaning apparatus on hinges, a first sensor situated within the first housing operable to determine the cleanliness of the entity, a second sensor situated within the first housing operable to activate and deactivate the cleaning module depending on the position of the entity in the system, and a plurality of seals mounted to the first housing operable to seal and isolate a portion of the entity in the first housing. A coating preparation module is coupled to the chassis, the coating preparation module including a second housing, the second housing defining a channel for allowing the entity to move axially through the coating preparation module, the movement being relative to the coating preparation module, at least one section on the second housing moveably mounted to the second housing on hinges, a coating preparation apparatus with coating preparation elements situated within the second housing and operable to prepare the entity for coating as it travels through the system, at least one section on the coating preparation apparatus moveably mounted to the coating preparation apparatus on hinges, a third sensor situated within the second housing operable to determine whether the entity has been properly prepared for coating, a fourth sensor situated within the second housing operable to activate and deactivate the coating preparation module depending on the position of the entity in the system, and a plurality of seals mounted to the second housing for sealing and isolating a portion of the entity in the second housing. A coating module is coupled to the chassis, the coating module including a third housing, the third housing defining a channel for allowing an entity to move axially through the coating module, the movement being relative to the coating module, at least one section on the third housing moveably mounted to the third housing on hinges, a coating apparatus with coating elements situated within the third housing and operable to coat the entity as it travels through the system, at least one section on the coating apparatus moveably mounted to the coating apparatus on hinges, a fifth sensor situated within the third housing operable to determine the quality of the coating applied to the entity, a sixth sensor situated within the third housing operable to activate and deactivate the coating module depending on the position of the entity in the system, and a plurality of seals mounted to the third housing for sealing and isolating a portion of the entity in the third housing.

According to another aspect of the present invention, a method for field coating a pipeline is provided including providing a pipeline, the pipeline including a weld zone, providing a field coating system, the system including a cleaning module, a coating preparation module, and a coating module, moving the weld zone axially through the system, detecting the weld zone entering the cleaning module, activating the cleaning module, detecting the weld zone exiting the cleaning module, deactivating the cleaning module, determining the weld zone is clean, detecting the weld zone entering the coating preparation module, activating the coating preparation module, detecting the weld zone exiting the coating preparation module, deactivating the coating preparation module, determining the weld zone is prepared for coating, detecting the weld zone entering the coating module. activating the coating module, detecting the weld zone exiting the coating module, deactivating the coating module, and determining the weld zone is coated.

According to another aspect of the present invention, a field coating system is provided that includes a chassis that is moveably mounted to a support structure. A cleaning module is coupled to the chassis, the cleaning module including a first housing, the first housing defining a channel for allowing the entity to move axially through the cleaning module, the movement being relative to the cleaning module, at least one section on the first housing moveably mounted to the first housing on hinges, a cleaning apparatus with cleaning elements situated within the first housing and operable to clean an entity as it travels through the system, at least one section on the cleaning apparatus moveably mounted to the cleaning apparatus on hinges, a first sensor situated within the first housing operable to determine the cleanliness of the entity, a second sensor situated within the first housing operable to activate and deactivate the cleaning module depending on the position of the entity in the system, and a plurality of seals mounted to the first housing operable to seal and isolate a portion of the entity in the first housing. A coating preparation module is coupled to the chassis, the coating preparation module comprising a second housing, the second housing defining a channel for allowing the entity to move axially through the coating preparation module, the movement being relative to the coating preparation module, at least one section on the second housing moveably mounted to the second housing on hinges, a coating preparation apparatus with coating preparation elements situated within the second housing and operable to prepare the entity for coating as it travels through the system, at least one section on the coating preparation apparatus moveably mounted to the coating preparation apparatus on hinges, a third sensor situated within the second housing operable to determine whether the entity has been properly prepared for coating, a fourth sensor situated within the second housing operable to activate and deactivate the coating preparation module depending on the position of the entity in the system, and a plurality of seals mounted to the second housing for sealing and isolating a portion of the entity in the second housing. A coating module is coupled to the chassis, the coating module comprising a third housing, the third housing defining a channel for allowing an entity to move axially through the coating module, the movement being relative to the coating module, at least one section on the third housing moveably mounted to the third housing on hinges, a coating apparatus with coating elements situated within the third housing and operable to coat the entity as it travels through the system, at least one section on the coating apparatus moveably mounted to the coating apparatus on hinges, a fifth sensor situated within the third housing operable to determine the quality of the coating applied to the entity, a sixth sensor situated within the third housing operable to activate and deactivate the coating module depending on the position of the entity in the system, and a plurality of seals mounted to the third housing for sealing and isolating a portion of the entity in the third housing.

According to another aspect of the present invention, a field coating system is provided that includes a chassis which is moveably mounted to a support structure with at least one actuator coupled to the chassis, the at least one actuator operable to move the chassis. A cleaning module is coupled to the chassis, the cleaning module comprising a first housing, the first housing defining a channel for allowing the entity to move axially through the cleaning module, the movement being relative to the cleaning module, at least one section on the first housing moveably mounted to the first housing on hinges, a cleaning apparatus with cleaning elements situated within the first housing and operable to clean an entity as it travels through the system, at least one section on the cleaning apparatus moveably mounted to the cleaning apparatus on hinges, a first sensor situated within the first housing operable to determine the cleanliness of the entity, a second sensor situated within the first housing operable to activate and deactivate the cleaning module depending on the position of the entity in the system, and a plurality of seals mounted to the first housing operable to seal and isolate a portion of the entity in the first housing. A coating preparation module is coupled to the chassis, the coating preparation module comprising a second housing, the second housing defining a channel for allowing the entity to move axially through the coating preparation module, the movement being relative to the coating preparation module, at least one section on the second housing moveably mounted to the second housing on hinges, a coating preparation apparatus with coating preparation elements situated within the second housing and operable to prepare the entity for coating as it travels through the system, at least one section on the coating preparation apparatus moveably mounted to the coating preparation apparatus on hinges, a third sensor situated within the second housing operable to determine whether the entity has been properly prepared for coating, a fourth sensor situated within the second housing operable to activate and deactivate the coating preparation module depending on the position of the entity in the system, and a plurality of seals mounted to the second housing for sealing and isolating a portion of the entity in the second housing. A coating module is coupled to the chassis, the coating module comprising a third housing, the third housing defining a channel for allowing an entity to move axially through the coating module, the movement being relative to the coating module, at least one section on the third housing moveably mounted to the third housing on hinges, a coating apparatus with coating elements situated within the third housing and operable to coat the entity as it travels through the system, at least one section on the coating apparatus moveably mounted to the coating apparatus on hinges, a fifth sensor situated within the third housing operable to determine the quality of the coating applied to the entity, a sixth sensor situated within the third housing operable to activate and deactivate the coating module depending on the position of the entity in the system, and a plurality of seals mounted to the third housing for sealing and isolating a portion of the entity in the third housing.

According to another aspect of the present invention, a method for field coating a pipeline is provided that includes providing a pipeline, the pipeline including a weld zone, providing a support structure, providing a field coating system, the system including a cleaning module, a coating preparation module, and a coating module, coupled to a chassis, the chassis moveably mounted on the support structure, holding the pipeline in a stationary position, moving the field coating system over the weld zone, detecting the cleaning module entering the weld zone, activating the cleaning module, detecting the cleaning module exiting the weld zone, deactivating the cleaning module, determining the weld zone is clean, detecting the coating preparation module entering the weld zone, activating the coating preparation module, detecting the coating preparation module exiting the weld zone, deactivating the coating preparation module, determining the weld zone is prepared for coating, detecting the coating module entering the weld zone, activating the coating module, detecting the coating module exiting the weld zone, deactivating the coating module, and determining the weld zone is coated.

According to another aspect of the present invention, a method for field coating a pipeline is provided that includes providing a pipeline, the pipeline including a weld zone, providing a support structure, providing a field coating system, the system including a cleaning module, a coating preparation module, and a coating module, coupled to a chassis, the chassis moveably mounted on the support structure, coupling at least one actuator to the chassis, the at least one actuator operable to move the chassis, holding the pipeline in a stationary position, activating the actuator to move the field coating system over the weld zone, detecting the cleaning module entering the weld zone, activating the cleaning module, detecting the cleaning module exiting the weld zone, deactivating the cleaning module, determining the weld zone is clean, detecting the coating preparation module entering the weld zone, activating the coating preparation module, detecting the coating preparation module exiting the weld zone, deactivating the coating preparation module, determining the weld zone is prepared for coating, detecting the coating module entering the weld zone, activating the coating module, detecting the coating module exiting the weld zone, deactivating the coating module, and determining the weld zone is coated.

### BRIEF DESCRIPTION OF THE DRAWINGS

FIG. 1 is a side view illustrating an embodiment of a conventional S-lay vessel constructing a pipeline.

FIG. 2 is a side view illustrating an embodiment of a conventional J-lay vessel constructing a pipeline.

FIG. 3 is a side view illustrating an embodiment of a conventional J-lay vessel constructing a pipeline.

FIG. 4 is a side view illustrating an embodiment of a conventional J-lay vessel constructing a pipeline.

FIG. 5a is a side view illustrating an embodiment of a conventional J-lay vessel constructing a pipeline.

FIG. 5b is a side view illustrating an embodiment of a conventional J-lay vessel constructing a pipeline.

FIG. 6 is a perspective view illustrating an embodiment of two conventional pipeline sections welded together with the weld zone uncoated.

FIG. 7 is a side view illustrating an exemplary embodiment of a system for field coating including a coating preparation module and a coating module.

FIG. 7a is a cross-sectional view of the coating preparation module of the system of FIG. 7.

FIG. 7b is a cross-sectional view of the coating module of the system of FIG. 7.

FIG. 7c is a cross-sectional view of the coating preparation module of FIG. 7a.

FIG. 7d is a cross-sectional view of the coating module of FIG. 7b.

FIG. 8 is a schematic view illustrating an exemplary embodiment of a method for performing a field coating process.

FIG. 9 is a schematic view illustrating an exemplary embodiment of a method for performing a coating preparation process.

FIG. 10 is a schematic view illustrating an exemplary embodiment of a method for performing a coating process.

FIG. 11 is a side view illustrating an exemplary embodiment of a system for field coating including a cleaning module, a coating preparation module, and a coating module.

FIG. 11a is a cross-sectional view illustrating the cleaning module of the system of FIG. 11.

FIG. 11b is a cross-sectional view of the cleaning module of FIG. 11a.

FIG. 12 is a schematic view illustrating an exemplary embodiment of a method for performing a field coating process.

FIG. 13 is a schematic view illustrating an exemplary embodiment of a method for performing a cleaning process.

FIG. 14 is a side view illustrating an exemplary embodiment of a system for field coating, including a cleaning module, a cleaning preparation module, and a coating module.

FIG. 15 is a schematic view illustrating an exemplary embodiment of a method for performing a field coating process.

FIG. 16 is a side view illustrating an exemplary embodiment of a system for field coating, including a cleaning module, a cleaning preparation module, and a coating module.

FIG. 17 is a schematic view illustrating an exemplary embodiment of a method for performing a field coating process.

### DETAILED DESCRIPTION

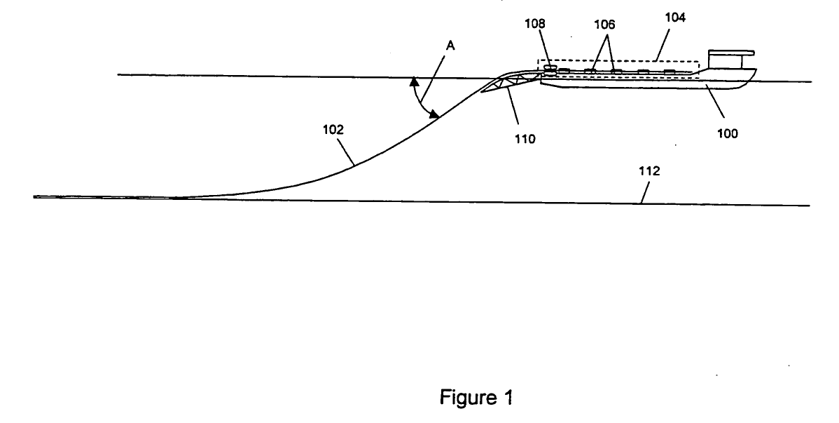

Referring to FIG. 1 of the drawings, a conventional S-lay vessel 100 is illustrated. Vessel 100 is used for constructing a conventional pipeline 102. Vessel 100 includes a conventional construction ramp 104 mounted on the vessel 100. Construction ramp 104 includes a plurality of conventional working stations 106 and a conventional tensioning system 108 situated along the ramp 102. A conventional stringer 110 is mounted to an end of the vessel 100.

In operation, the pipeline 102 is constructed from sections of pipeline stored on vessel 100. Working stations 106 carry out the construction process for pipeline 102 which may involve operations such as lining up a plurality of pipe sections, beginning a weld, finishing a weld, inspecting a weld, and coating a weld. Once pipeline sections have been constructed into pipeline 102, the pipeline 102 travels through tensioning system 108 and over stringer 110. Tensioning system 108 provides tension in the pipeline 102 during its journey to a seabed 112, and stringer 110 provides pipeline 102 with a gentle departure angle A from the vessel 100 to a seabed 112. Tensioning system 108 and stringer 110 are employed so that the pipeline will not buckle under its own weight as it nears the seabed 112.

However, in deep water, the weight of the pipeline 102 becomes high enough that the tension and departure angle required to prevent the pipeline 102 from buckling near the seabed 112 under its own weight using an S-lay vessel 100 becomes impractical.

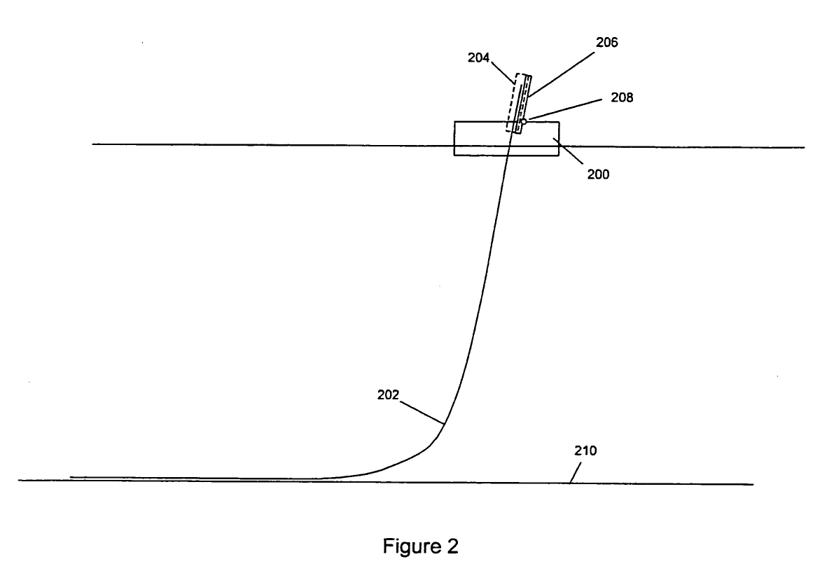

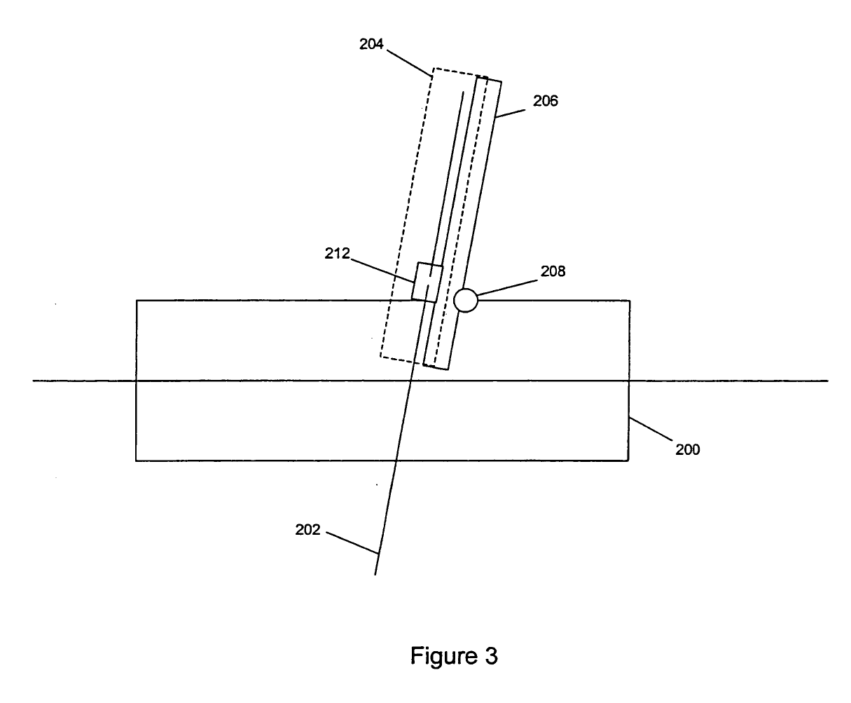

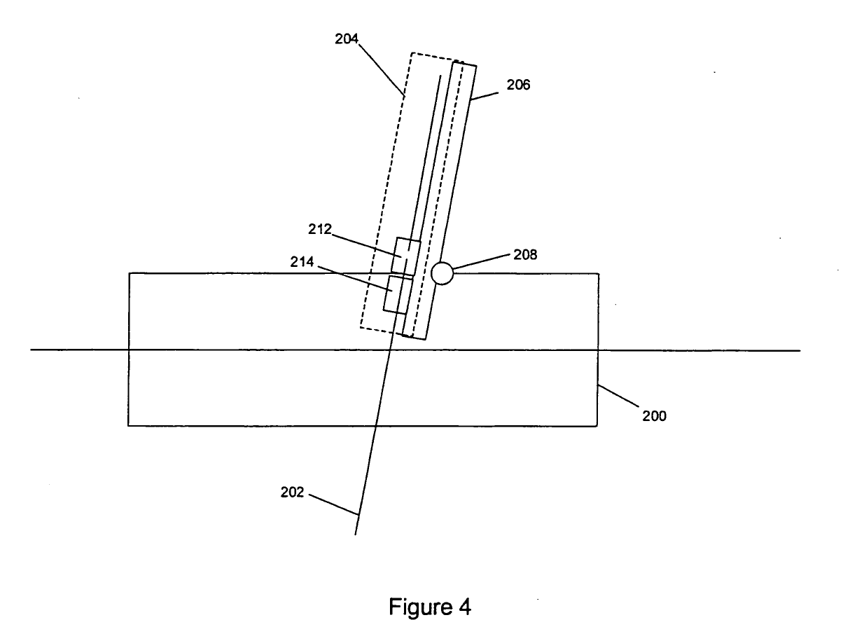

Referring to FIGS. 2, 3, and 4, a conventional J-lay vessel 200 for constructing a conventional pipeline 202 is illustrated. Vessel 200 includes a conventional construction ramp 204 mounted to a conventional pipelay tower 206 which is moveably mounted to the vessel by way of a conventional hinge 208. Construction ramp 204 can only support a limited number of working stations, such as a conventional working station 212, FIG. 3, or a conventional working station 212 and a conventional working station 214, FIG. 4. The working stations may be main working stations, such as working stations 212 in FIGS. 3 and 4, or an auxiliary working station, such as working station 214 in FIG. 4.

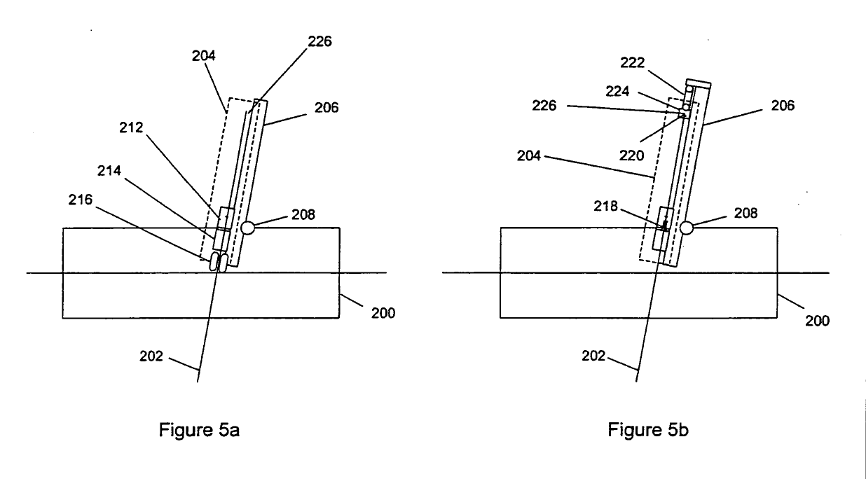

Referring to FIGS. 5a and 5b, construction ramp 204 includes a conventional suspension system such as a set of conventional tensioners 216, illustrated in FIG. 5a, a conventional mechanical clamp for pipelines with no collar, not illustrated, a conventional hang off table 218, along with a conventional hoisting system 222 and a conventional head clamp 224, for pipelines with a conventional collar 220 on a pipeline end 226, illustrated in FIG. 5b, or a variety of other suspension systems known in the art.

In operation, the construction ramp 204 may be rotated to a substantially vertical position, allowing the weight of pipeline 202 to be supported by the suspension system on the construction ramp 204, and the departure angle of the pipeline 202 to be adjusted to a desired value by rotating the pipelay tower 206. Pipeline 202 may then be constructed on the ramp 204 and laid on a seabed 210 in deep water without buckling under its own weight. In a vessel 200, such as the vessel shown in FIGS. 4, 5a, and 5b, with working station 212 and working station 214, typically pipeline 202 lineup, preheating, welding and weld inspection are done in working station 212. Working station 214 is then used for the field coating process, which can produce dust and vapor.

During activities on the area of the pipeline 202 to be worked on in the working station 212, the pipeline 202 may be held in the set of tensioners 216, illustrated in FIG. 5a. Once activities in working station 212 have been completed, the area of the pipeline 202 to be worked on is lowered to the working station 214. Pipeline 202 may be lowered using the set of tensioners 216 or a climbing mechanism of the mechanical clamp.

Alternatively, for pipelines with a collar 220, during activities on the area of the pipeline 202 to be worked on in the working station 212, the pipeline may be held in a hang off table 218, illustrated in FIG. 5b. The pipeline may be lifted by a hoisting system 222 holding on the collar 220 of the pipeline 202 via a head clamp 224. With the pipeline 202 suspended in the head clamp 224, the hang off table 218 may be opened and the pipeline 202 lowered until the area of the pipeline 202 to be worked on is in the working station 214.

Once the activities on the area of the pipeline to be worked on in the working station 214 have been completed, the pipeline 202 is further lowered until the end 226 of the pipeline 202 is in the working station 212. Pipeline construction may then be continued by repeating the process.

Due to structural considerations, the construction ramp used on a J-lay vessel is much shorter than the ramp used in an S-lay vessel. As a result, the ramp used on a J-lay vessel can contain only a very limited number of working stations for pipeline construction. Most J-lay vessels will have one working station, or one main and one auxiliary working station close to each other, while the very large J-lay vessels may have two working stations. The efficiency of these working stations are critical to the efficiency of pipeline construction, as they lie in the critical path of pipeline construction.

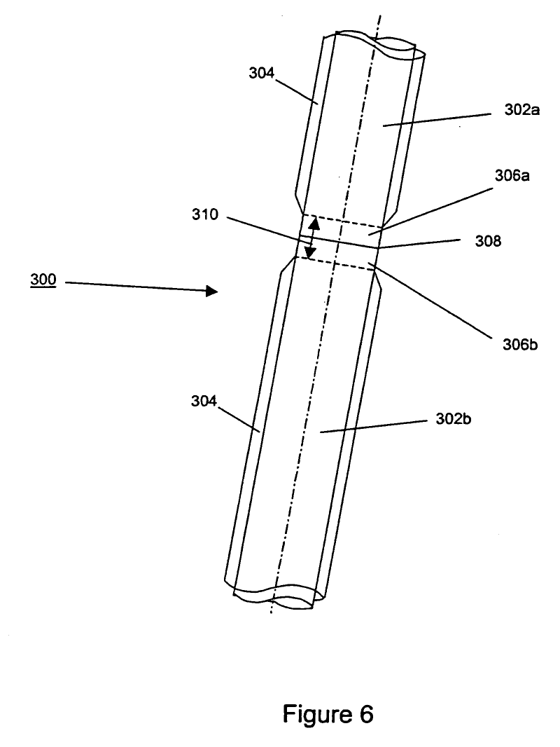

Referring to FIG. 6, a conventional pipeline 300 to be coated is illustrated. Pipeline 300 is constructed from a plurality of conventional pipeline sections 302a and 302b which are typically provided with a conventional coating 304. Coating 304 may be an anti-corrosion coating like fusion bonded epoxy, an insulation coating with an insulating material, or a weight coating with a heavy material such as concrete. Pipeline 300 to be coated has no coating 304 over an area 306a and 306b on pipeline section 302a and 302b, respectively, as it must be cut back in order to allow pipeline sections 302a and 302b to be welded together. A conventional weld 308 is made to hold sections 302a and 302b together, leaving a weld zone 310 on pipeline 300.

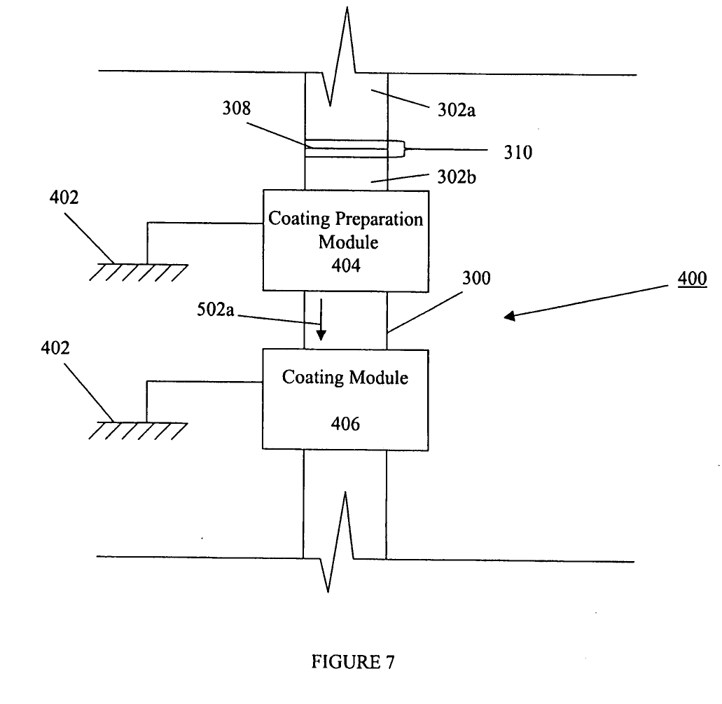

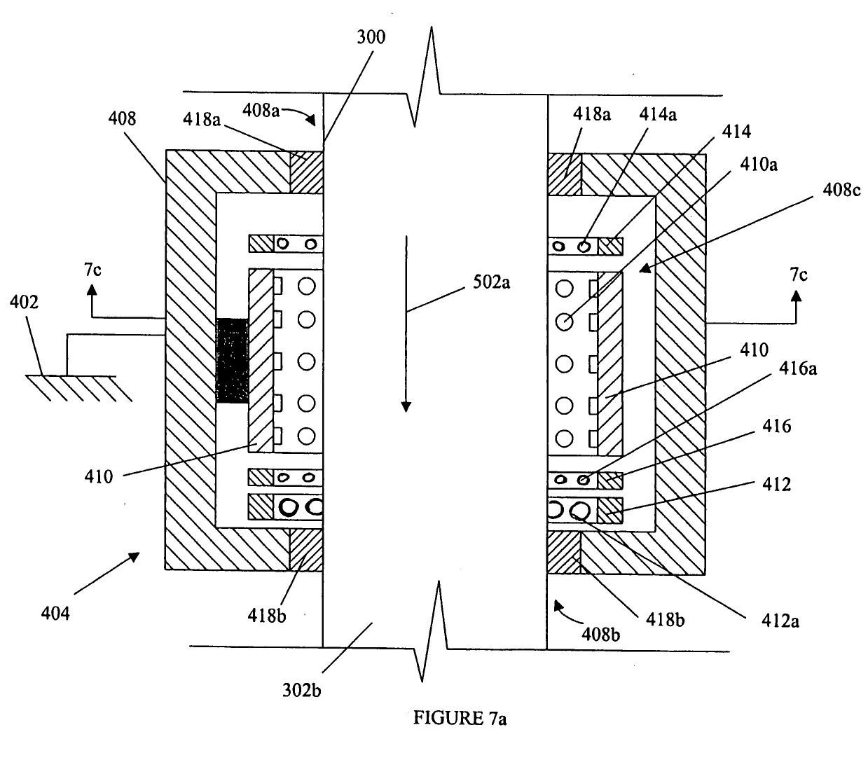

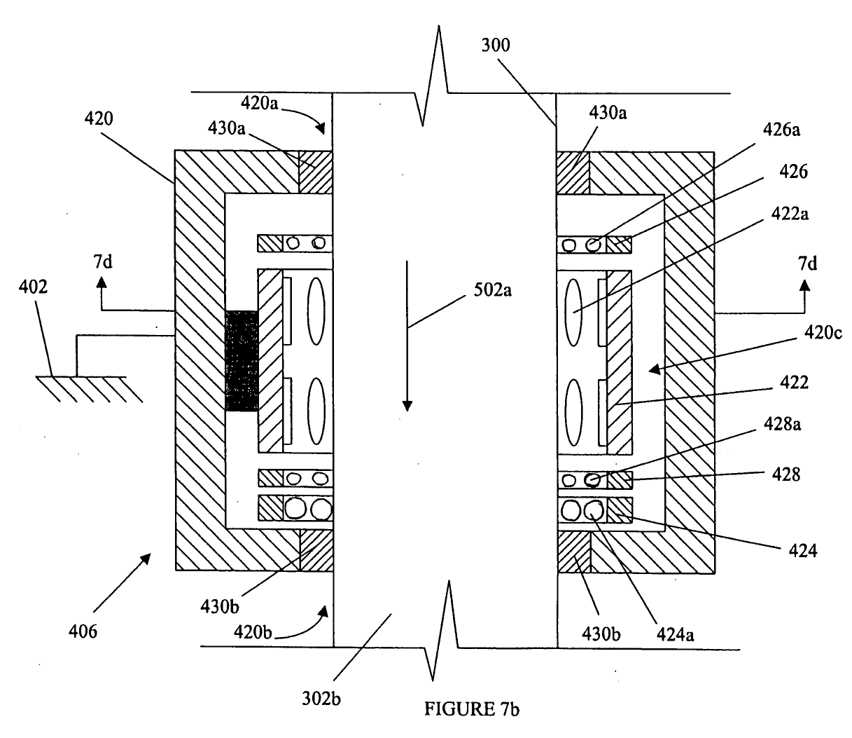

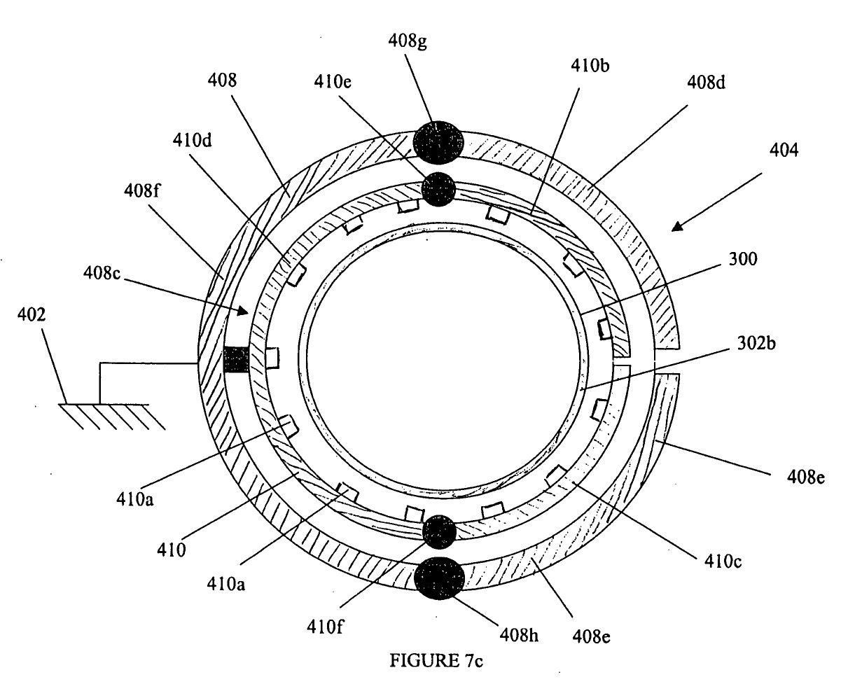

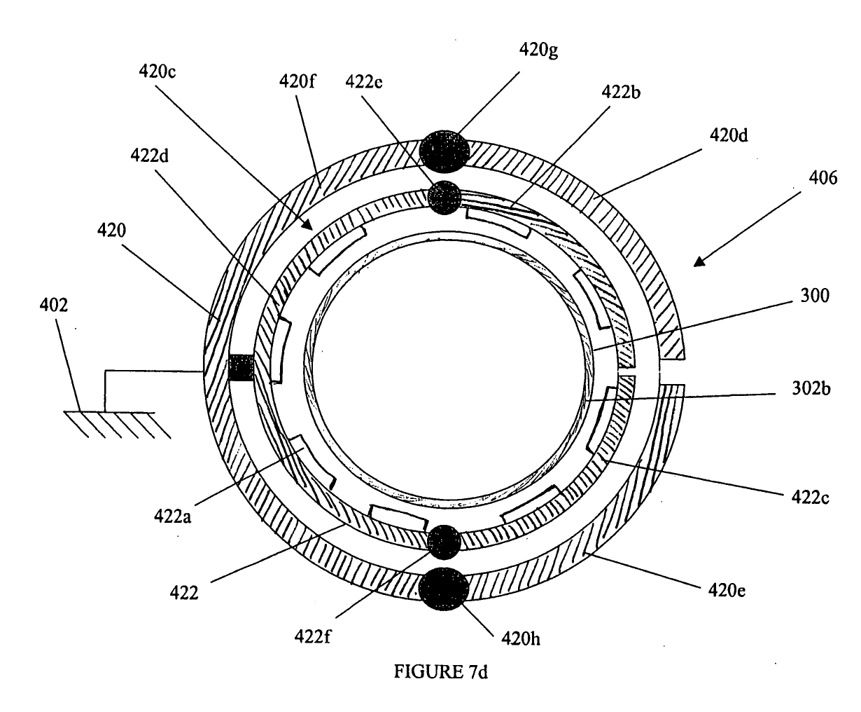

Referring to FIGS. 7, 7a, 7b, 7c, and 7d, an exemplary embodiment of a field coating system 400 includes a chassis 402 that supports a coating preparation module 404 and a coating module 406. The coating preparation module 404 includes a housing 408 that defines an inlet passage 408a, an outlet passage 408b, an interior chamber 408c, and includes upper and lower arcuate sections, 408d and 408e, that are pivotally coupled to a supporting arcuate section 408f by hinges, 408g and 408h, respectively. One or both of the hinges 408g and 408h may include a lock. The coating preparation module 404 further includes one or more conventional tubular pipe coating preparation modules 410, each having one or more pipe coating preparation elements 410a, positioned within the interior chamber 408c and coupled to the housing 408, conventional tubular pipe coating preparation quality control sensor 412 having one or more pipe coating preparation quality control sensing elements 412a positioned within the interior chamber and coupled to the housing 408, conventional tubular pipe coating preparation start control sensor 414 having one or more pipe coating preparation start control sensing elements 414a positioned within the interior chamber and coupled to the housing 408, and conventional tubular pipe coating preparation stop control sensor 416 having one or more pipe coating preparation stop control sensing elements 416a positioned within the interior chamber and coupled to the housing 408. Pipe coating preparation elements 410a may be fixed to the tubular pipe coating preparation modules 410 or may be moveably mounted on the tubular pipe coating preparation modules 410. The tubular pipe coating preparation module 410 further includes upper and lower arcuate sections, 410b and 410c, that are pivotally coupled to a supporting arcuate section 410d by hinges, 410e and 410f, respectively. One or both of the hinges 410e and 410f may include a lock. Tubular sealing elements, 418a and 418b, are positioned adjacent the inlet and outlet passages, 408a and 408b, respectively, of the housing 408 for reasons to be described.

In an exemplary embodiment, the pipe coating preparation modules 410 may be, for example, conventional commercially available pipe coating preparation modules such as, for example, pipe coating preparation modules available from Selmers B. V., Biesland 3, 1948 R J Beverwijk, The Netherlands, http://www.selmers.com; Radyne Corporation, 211 W. Bodenstreet, Milwaukee Wis., 53207, USA, http://www.radyne.com; Vietz GmbH, Frankische Strasse 30, D-30455 Hannover, Germany, http://www.vietz.de; and Maran & Co. Ltd, 190 Clarence Gate Gardens, London NWI 6AD, England, http://www.maran.co.uk. In an exemplary embodiment, the tubular pipe coating preparation quality control sensor 412 may be, for example, conventional commercially available pipe coating preparation quality control sensors such as, for example, pipe coating preparation quality control sensors available from Sick Industrial Sensors AG, Sebastian-Kneipp-Strasse 1, 79183 Waldkirch, Germany, http://www.sick.de. In an exemplary embodiment, the tubular pipe coating preparation start control sensor 414 and tubular pipe coating preparation stop control sensor 416 may be, for example, conventional commercially available pipe coating preparation start and stop control sensors such as, for example, pipe coating preparation start and stop control sensors available from Sick Industrial Sensors AG, Sebastian-Kneipp-Strasse 1, 79183 Waldkirch, Germany, http://www.sick.de.

The coating module 406 includes a housing 420 that defines an inlet passage 420a, an outlet passage 420b, an interior chamber 420c, and includes upper and lower arcuate sections, 420d and 420e, that are pivotally coupled to a supporting arcuate section 420f by hinges, 420g and 420h, respectively. One or both of the hinges 420g and 420h may include a lock. The coating module 406 further includes one or more conventional tubular pipe coating modules 422, each having one or more pipe coating elements 422a, positioned within the interior chamber 420c and coupled to the housing 420, conventional tubular pipe coating quality control sensor 424 having one or more pipe coating quality control sensing elements 424a positioned within the interior chamber and coupled to the housing 420, conventional tubular pipe coating start control sensor 426 having one or more pipe cleaning start control sensing elements 426a positioned within the interior chamber and coupled to the housing 420, and conventional tubular pipe cleaning stop control sensor 428 having one or more pipe cleaning stop control sensing elements 428a positioned within the interior chamber and coupled to the housing 420. Pipe coating elements 422a may be fixed to the tubular pipe coating modules 422 or may be moveably mounted on the tubular pipe coating modules 422. The tubular pipe coating module 422 further includes upper and lower arcuate sections, 422b and 422c, that are pivotally coupled to a supporting arcuate section 422d by hinges, 422e and 422f. One or both of the hinges 422e and 422f may include a lock. Tubular sealing elements, 430a and 430b, are positioned adjacent the inlet and outlet passages, 420a and 420b, respectively, of the housing 420 for reasons to be described.

In an exemplary embodiment, the pipe coating modules 422 may be, for example, conventional commercially available pipe coating modules such as, for example, pipe coating modules available from Selmers B. V., Biesland 3, 1948 R J Beverwijk, The Netherlands, http://www.selmers.com; Bauhuis International B. V., P.O. Box 172, 7470 AD Goor, The Netherlands, http://www.bauhuis.com; Tapecoat, P.O. Box 631, Evanston, Ill. 60204-0631, USA, http://www.tapecoat.com; and Eupec PipeCoatings, Friedrich-Ebert-Strasse 154, 45473 Muhlheim an der Ruhr, Germany, http://www.offshore-technology.com. In an exemplary embodiment, the tubular pipe coating quality control sensor 424 may be, for example, conventional commercially available pipe coating quality control sensors such as, for example, pipe coating quality control sensors available from Sick Industrial Sensors AG, Sebastian-Kneipp-Strasse 1, 79183 Waldkirch, Germany, http://www.sick.de. In an exemplary embodiment, the tubular pipe coating start control sensor 426 and tubular pipe coating stop control sensor 428 may be, for example, conventional commercially available pipe coating start and stop control sensors such as, for example, pipe coating preparation start and stop control sensors available from Sick Industrial Sensors AG, Sebastian-Kneipp-Strasse 1, 79183 Waldkirch, Germany, http://www.sick.de.

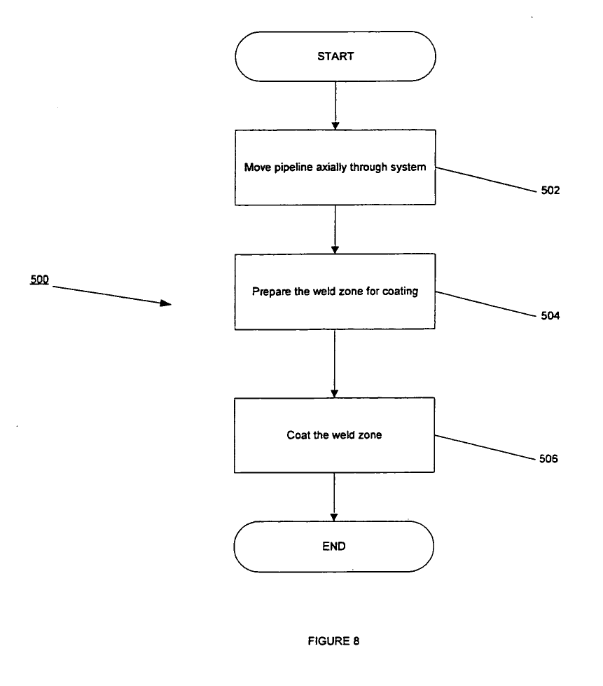

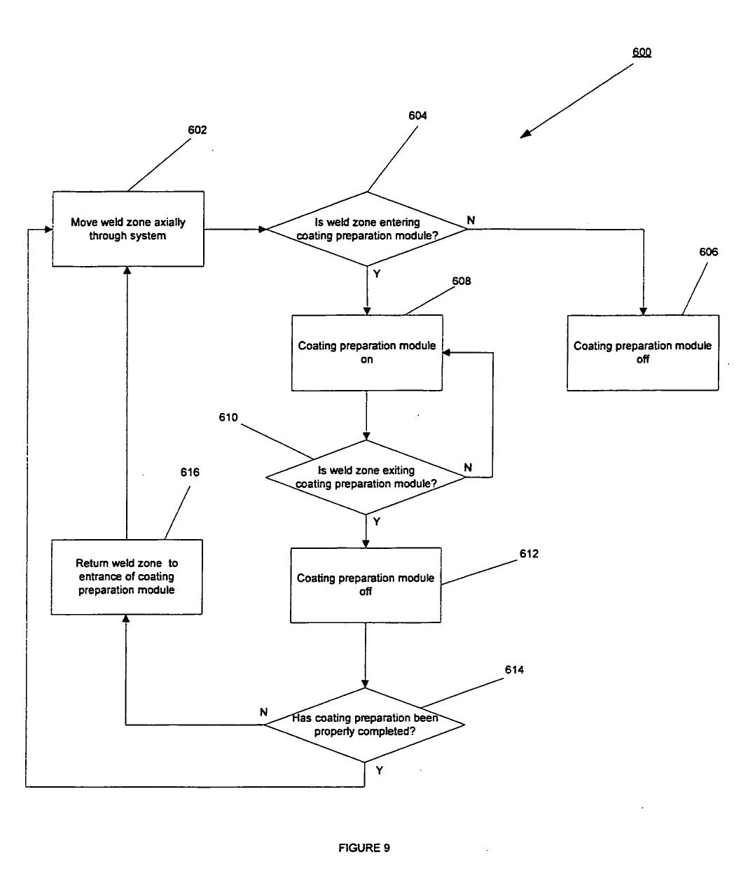

In an exemplary embodiment, during operation of the system 400, as illustrated in FIGS. 7, 7a, 7b, 7c, 7d, and 8, a method 500 for coating a pipeline is implemented using the system in which, in step 502, a pipeline 300 including a plurality of pipeline segments, 302a and 302b, that are coupled end to end by a welded joint 308 in a weld zone 310, is displaced into and through the system in a direction 502a. In step 504, the weld zone 310 of the pipeline 300 is prepared for coating by the coating preparation module 404, and in step 506, the weld zone 310 of the pipeline 300 is coated by the coating module 406.

The system 400 may be secured to a stationary structure and the pipeline 300 may move through the system 400, or the pipeline 300 may be held stationary and the system 400 may move over the pipeline 400, possibly by employing system 400 as a hand held tool or moveably mounted on a structure. The pipeline 300 may be in any orientation as it travels through the system 400. For example, it may be in a vertical orientation, such as suspended in a vertical construction ramp in a J-lay vessel, as it travels through the system. In another example, it may be in a horizontal orientation, such as laid on the deck of a vessel, as it travels through the system.

In an exemplary embodiment, during operation of the system 400, as illustrated in FIGS. 7, 7a, 7c, 8, and 9, a method 600 for performing a coating preparation process is implemented using the system in which, in step 602, the weld zone 310 of the pipeline 300 is displaced into and through the system, in a direction 502a. At decision block 604, a start control sensor, such as start control sensor 414, detects whether the weld zone 310 has entered the coating preparation module 404. If the weld zone 310 has not entered the coating preparation module 404, the coating preparation module 404 remains off in step 606. However, if the weld zone 310 is detected entering the coating preparation module 404, the coating preparation module 404 is turned on in step 608. Tubular sealing elements, such as tubular sealing elements 418a and 418b, seal off and isolate the weld zone 310 in the coating preparation module 404. The pipe coating preparation elements 410a on coating preparation module 404 may use a variety of different means, such as a heating coil or nozzles to spray concrete, grout, or an adhesion layer, to prepare the surface of the pipeline 300 for coating. Coating preparation module 404 may not be used, such as when the weld zone 310 is to be coated with concrete and a rust covered surface on the pipeline 300 provides appropriate adhesion without a need for coating preparation. At decision block 610, a stop control sensor, such as stop control sensor 416, detects whether the weld zone 310 is exiting the coating preparation module 404. If the weld zone 310 is not exiting the coating preparation module 404, the coating preparation module 404 remains on in step 608. However, if the weld zone 310 is detected exiting the coating preparation module 404, the coating preparation module 404 is shut off in step 612. At decision block 614, a quality control sensor, such as quality control sensor 412, detects whether the coating preparation has been properly completed. In an exemplary embodiment, proper coating preparation is completed pursuant to a predetermined user defined specification. If the coating preparation has not been properly completed, the weld zone 310 is returned to the entrance of the coating preparation module 404 at step 616. The weld zone 310 is then displaced into and through the system at step 602 to repeat the coating preparation process. However, if the coating preparation has been properly completed, the weld zone 310 is displaced into and through the system, at step 602, to continue the field coating process.

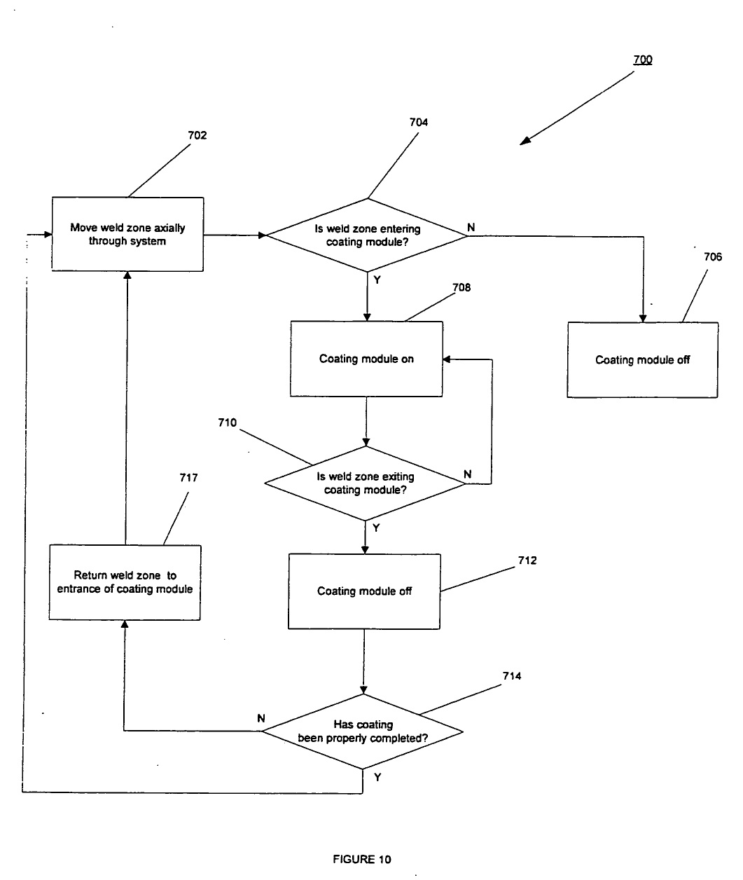

In an exemplary embodiment, during operation of the system 400, as illustrated in FIGS. 7, 7b, 7d, 8, and 10, a method 700 for performing a coating process is implemented using the system in which, in step 702, the weld zone 310 of the pipeline 300 is displaced into and through the system, in a direction 502a. At decision block 704, a start control sensor, such as start control sensor 426, detects whether the weld zone 310 has entered the coating module 406. If the weld zone 310 has not entered the coating module 406, the coating module 406 remains off in step 706. However, if the weld zone 310 is detected entering the coating module 406, the coating module 406 is turned on in step 708. Tubular sealing elements, such as tubular sealing elements 430a and 430b, seal off and isolate the weld zone 310 in the coating module 406. The pipe coating elements 422a on cleaning module 802 may use a variety of different means, such as nozzles or rollers, to coat the surface of the pipeline. The coating process may include laying several different layers on the pipeline 300, and possibly a cooling step. At decision block 710, a stop control sensor, such as stop control sensor 428, detects whether the weld zone 310 is exiting the coating module 406. If the weld zone 310 is not exiting the coating module 406, the coating module 406 remains on in step 708. However, if the weld zone 310 is detected exiting the coating module 406, the coating module 406 is shut off in step 712. At decision block 714, a quality control sensor, such as quality control sensor 424, detects whether the coating has been properly completed. In an exemplary embodiment, proper coating is completed pursuant to a predetermined user defined specification. If the coating has not been properly completed, the weld zone 310 is returned to the entrance of the coating module 406 at step 716. The weld zone 310 is then displaced into and through the system at step 702 to repeat the coating process. However, if the coating has been properly completed, the weld zone 310 is displaced through and out the system, at step 702.

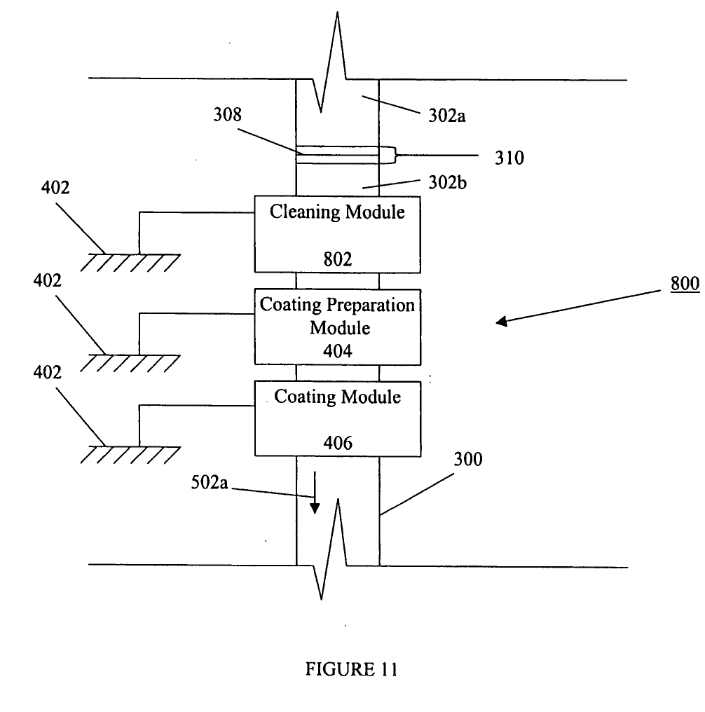

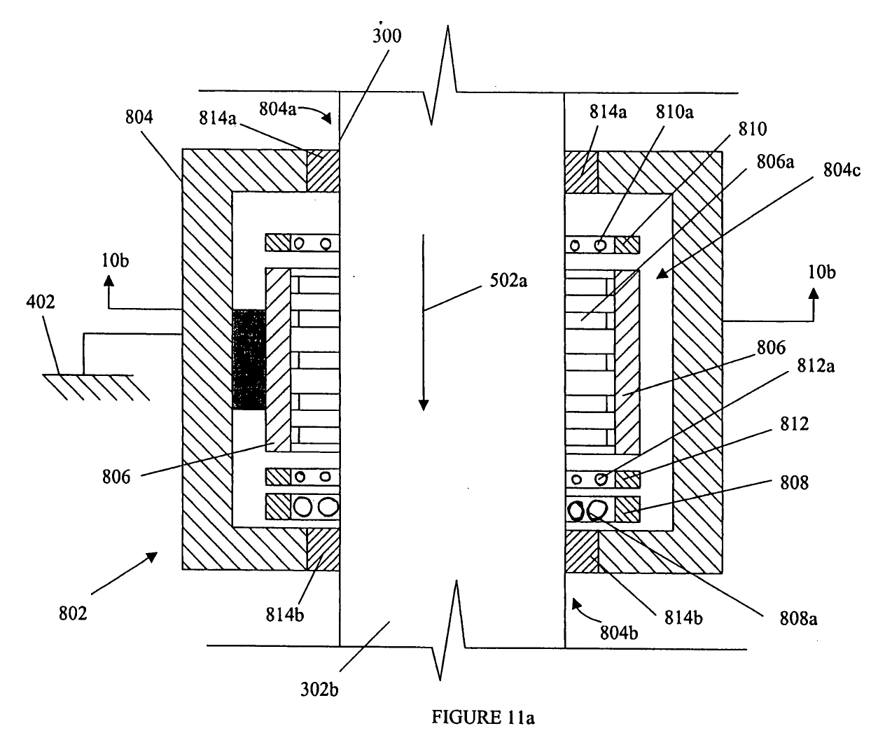

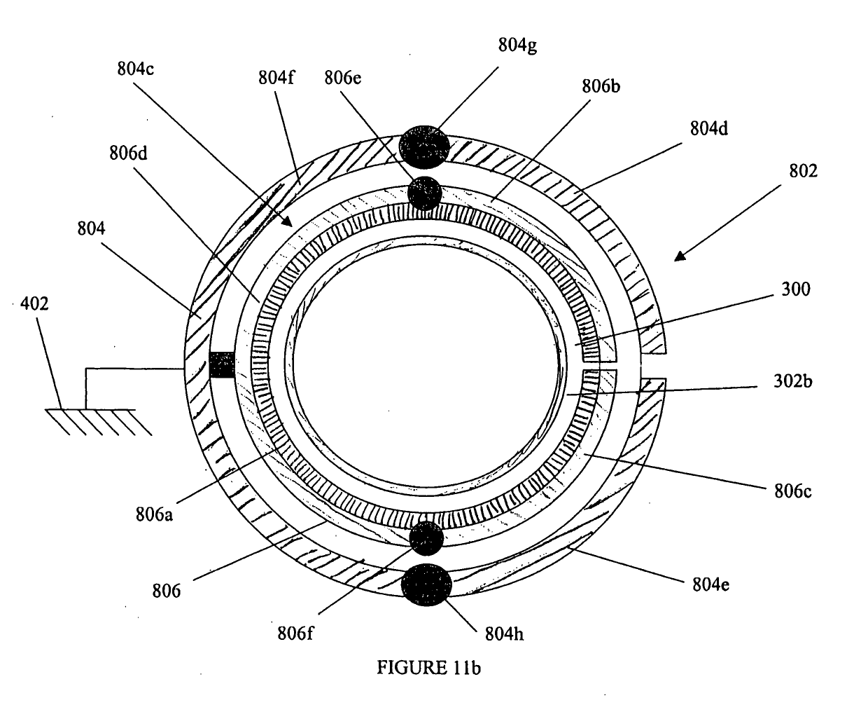

Referring now to FIGS. 11, 11a, and 11b, an alternative embodiment of a field coating system 800 is substantially identical in design and operation to field coating system 400 described above with reference to FIGS. 7, 7a, 7b, 7c, 7d, 9 and 10 with the addition of a cleaning module 802 supported by the chassis 402 and positioned before the coating preparation module 404 and the coating module 406.

The cleaning module 802 includes a housing 804 that defines an inlet passage 804a, an outlet passage 804b, an interior chamber 804c, and includes upper and lower arcuate sections, 804d and 804e, that are pivotally coupled to a supporting arcuate section 804f by hinges, 804g and 804h, respectively. One or both of the hinges 804g and 804h may include a lock. The cleaning module 802 further includes one or more conventional tubular pipe cleaning modules 806, each having one or more pipe cleaning elements 806a, positioned within the interior chamber 804c and coupled to the housing 804, conventional tubular pipe cleaning quality control sensor 808 having one or more pipe cleaning quality control sensing elements 808a positioned within the interior chamber and coupled to the housing 804, conventional tubular pipe cleaning start control sensor 810 having one or more pipe cleaning start control sensing elements 810a positioned within the interior chamber and coupled to the housing 804, and conventional tubular pipe cleaning stop control sensor 812 having one or more pipe cleaning stop control sensing elements 812a positioned within the interior chamber and coupled to the housing 804. Pipe cleaning elements 806a may be fixed to the tubular pipe cleaning modules 806 or may be moveably mounted on the tubular pipe cleaning modules 806. The tubular pipe cleaning module 806 further includes upper and lower arcuate sections, 806b and 806c, that are pivotally coupled to a supporting arcuate section 806d by hinges, 806e and 806f. One or both of the hinges 806e and 806f may include a lock. Tubular sealing elements, 814a and 814b, are positioned adjacent the inlet and outlet passages, 804a and 804b, respectively, of the housing 804 for reasons to be described.

In an exemplary embodiment, the pipe cleaning modules 806 may be, for example, conventional commercially available pipe cleaning modules such as, for example, pipe cleaning modules available from Selmers B. V., Biesland 3, 1948 R J Beverwijk, The Netherlands, http://www.selmers.com; and Bauhuis International B. V., P.O. Box 172, 7470 AD Goor, The Netherlands, http://www.bauhuis.com. In an exemplary embodiment, the tubular pipe cleaning quality control sensor 808 may be, for example, conventional commercially available pipe cleaning quality control sensors such as, for example, pipe cleaning quality control sensors available from Sick Industrial Sensors AG, Sebastian-Kneipp-Strasse 1, 79183 Waldkirch, Germany, http://www.sick.de. In an exemplary embodiment, the tubular pipe cleaning start control sensor 810 and tubular pipe cleaning stop control sensor 812 may be, for example, conventional commercially available pipe cleaning start and stop control sensors such as, for example, pipe cleaning start and stop control sensors available from Sick Industrial Sensors AG, Sebastian-Kneipp-Strasse 1, 79183 Waldkirch, Germany, http://www.sick.de.

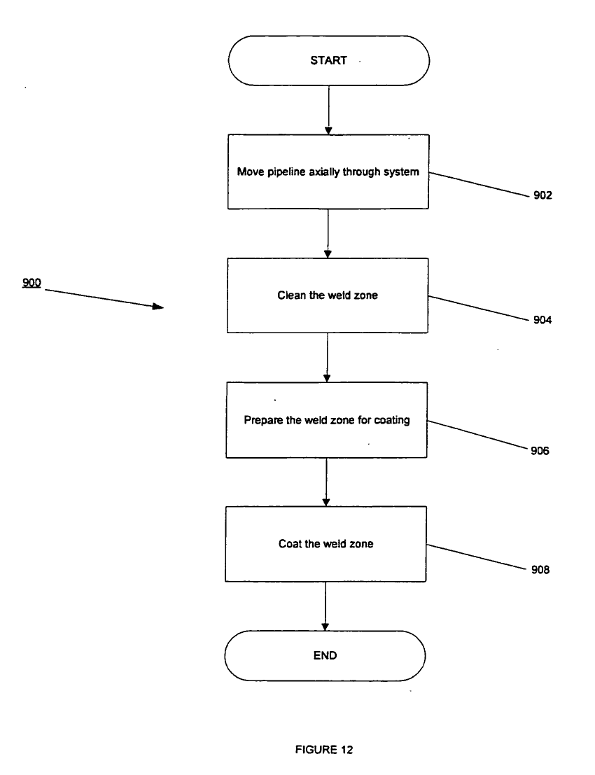

In an exemplary embodiment, during operation of the system 800, as illustrated in FIGS. 7a, 7b, 7c, 7d, 9, 10, 11, 11a, 11b, and 12, a method 900 of cleaning and coating a pipeline is implemented using the system in which, in step 902, a pipeline 300 including a plurality of pipeline segments, 302a and 302b, that are coupled end to end by a welded joint 308 in a weld zone 310, are displaced into and through the system in a direction 502a. In step 904, the weld zone 310 of the pipeline 300 is cleaned by the cleaning module 802, in step 906, the weld zone 310 of the pipeline 300 is prepared for coating by the coating preparation module 404, and in step 908, the weld zone 310 of the pipeline 300 is coated by the coating module 406.

The system 800 may be secured to a stationary structure and the pipeline 300 may move through the system 800, or the pipeline 300 may be held stationary and the system 800 may move over the pipeline 300, possibly by employing system 800 as a hand held tool or moveably mounted on a structure. The pipeline 300 may be in any orientation as it travels through the system 800. For example, it may be in a vertical orientation, such as suspended in a vertical construction ramp in a J-lay vessel, as it travels through the system. In another example, it may be in a horizontal orientation, such as laid on the deck of a vessel, as it travels through the system.

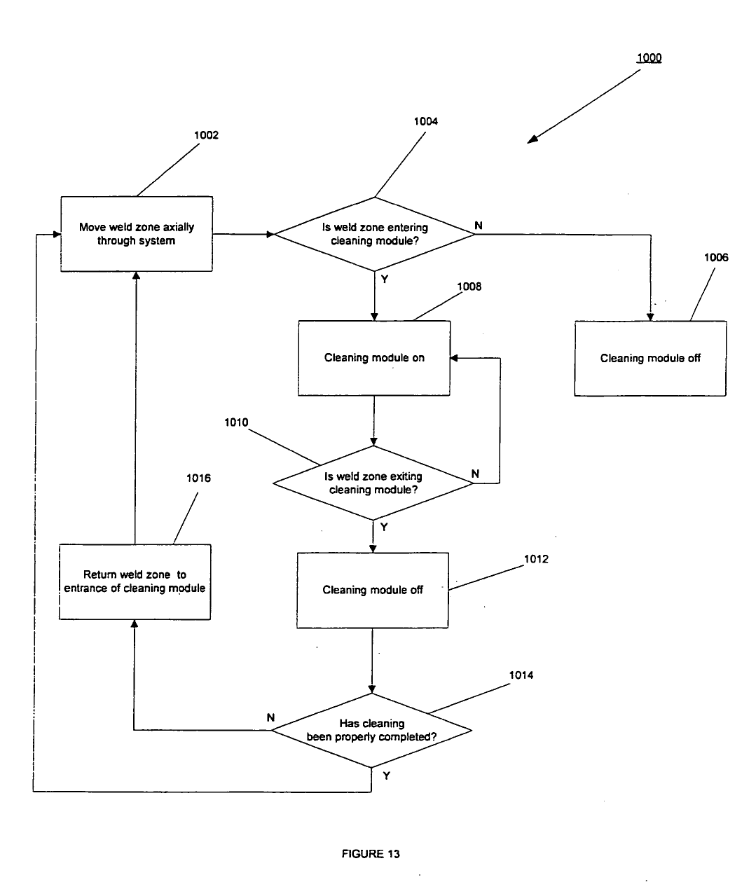

In an exemplary embodiment, during operation of the system 800, as illustrated in FIGS. 7a, 7b, 7c, 7d, 9, 10, 11, 11a, 11b, 12 and 13, a method 1000 for performing a cleaning process is implemented using the system in which, in step 1002, the weld zone 310 of the pipeline 300 is displaced into and through the system, in a direction 502a. At decision block 1004, a start control sensor, such as start control sensor 810, detects whether the weld zone 310 has entered the cleaning module 802. If the weld zone 310 has not entered the cleaning module 802, the cleaning module 802 remains off in step 1006. However, if the weld zone 310 is detected entering the cleaning module 802, the cleaning module 802 is turned on in step 1008. Tubular sealing elements, such as tubular sealing elements 814a and 814b, seal off and isolating the weld zone 310 in the cleaning module 802. The pipe cleaning elements 806a on cleaning module 802 may use a variety of different means, such as steel wire brushing, shot blasting, and grit blasting, to clean the surface of the pipeline. At decision block 1010, a stop control sensor, such as stop control sensor 812, detects whether the weld zone 310 is exiting the cleaning module 802. If the weld zone 310 is not exiting the cleaning module 802, the cleaning module 802 remains on in step 1008. However, if the weld zone 310 is detected exiting the cleaning module 802, the cleaning module 802 is shut off in step 1012. At decision block 1014, a quality control sensor, such as quality control sensor 412 or 424, detects whether the cleaning has been properly completed. In an exemplary embodiment, proper cleaning is completed pursuant to a predetermined user defined specification. If the cleaning has not been properly completed, the weld zone 310 is returned to the entrance of the cleaning module 802 at step 1016. The weld zone 310 is then displaced into and through the system at step 1002 to repeat the cleaning process. However, if the cleaning has been properly completed, the weld zone 310 is displaced into and through the system, at step 1002, to continue the field coating process.

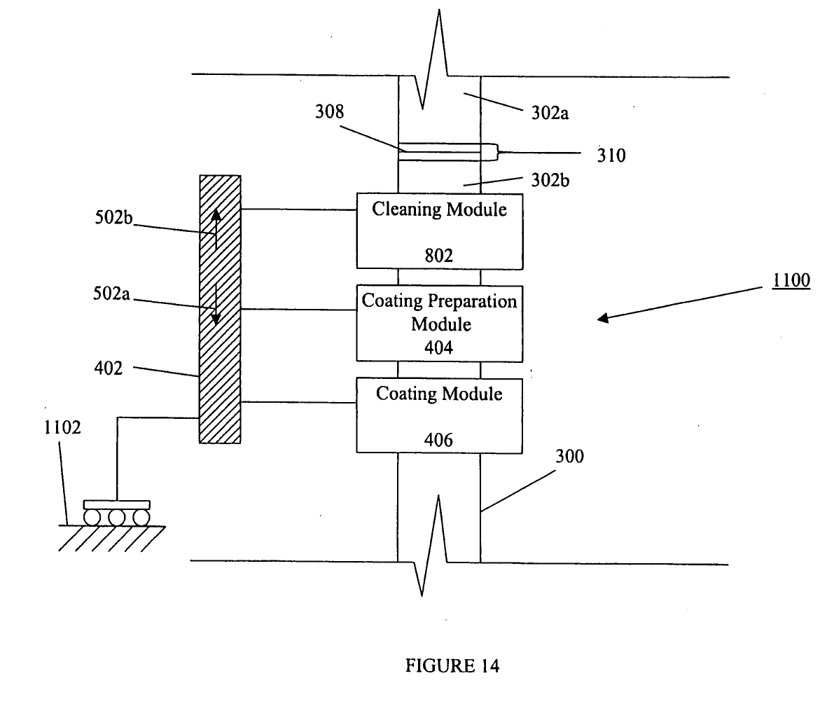

Referring now to FIG. 14, an alternative embodiment of a field coating system 1100 is substantially identical in design and operation to field coating system 800 described above with reference to FIGS. 7a, 7b, 7c, 7d, 9, 10, 11, 11a, 11b, 12 and 13, with provision of the chassis 402 which is free to move in direction 502a and direction 502b relative to a support structure 1102.

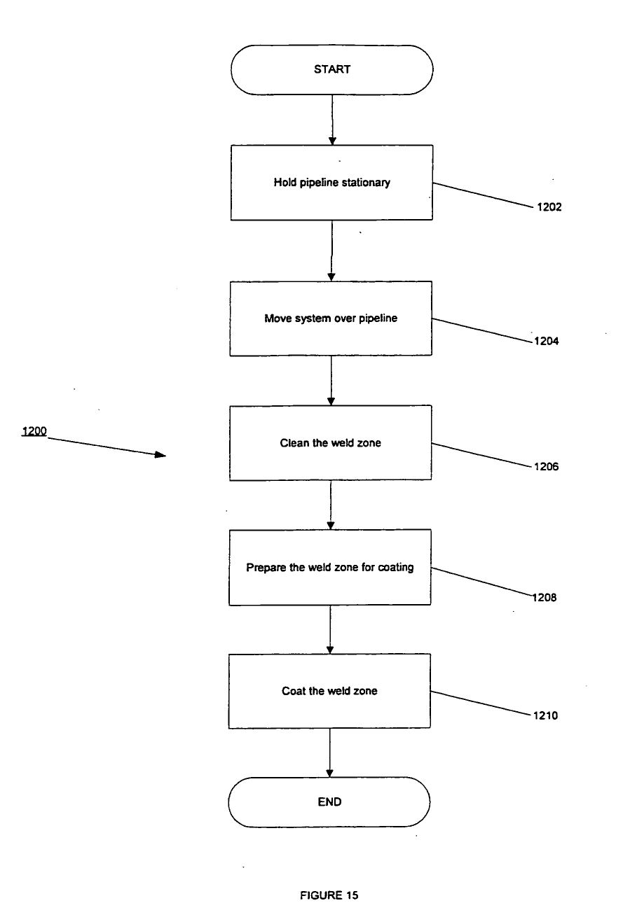

In an exemplary embodiment, during operation of the system 1100, as illustrated in FIGS. 7a, 7b, 7c, 7d, 9, 10, 11a, 11b, 13, 14 and 15, a method 1200 is implemented using the system in which, in step 1202, the pipeline 300 including a plurality of pipeline segments, 302a and 302b, that are coupled end to end by a welded joint 308 in a weld zone 310 is held in a stationary position relative to the support structure 1102. In step 1204, the chassis 402 coupled to cleaning module 802, coating preparation module 404, and coating module 406, is displaced around and over the pipeline, in direction 502b. In step 1206, the weld zone 310 of the pipeline 300 is cleaned by the cleaning module 802, in step 1208, the weld zone 310 of the pipeline 300 is prepared for coating by the coating preparation module 404, and in step 1210, the weld zone 310 of the pipeline 300 is coated by the coating module 406.

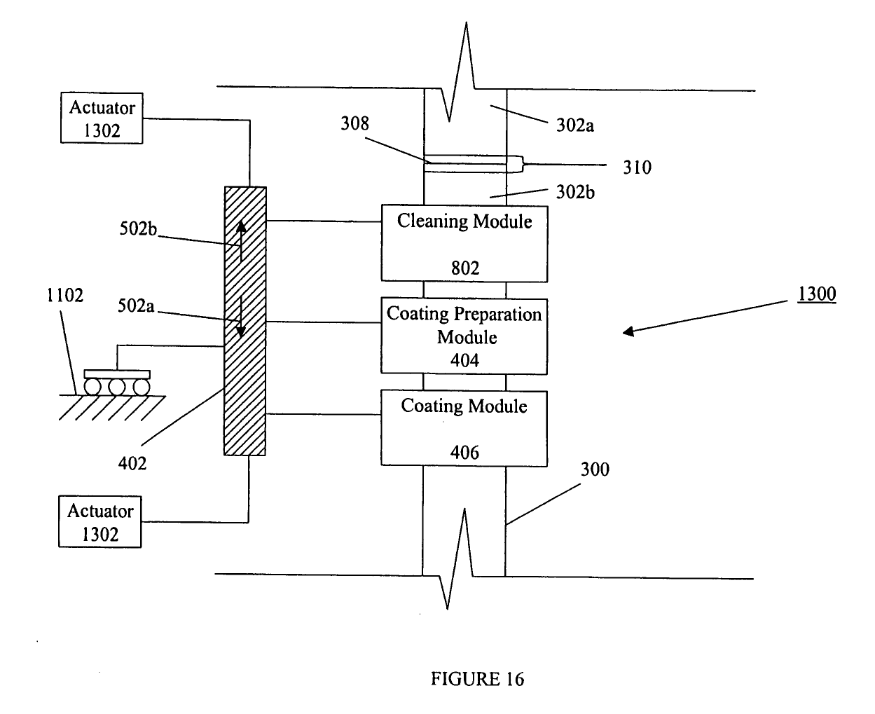

Referring now to FIG. 16, an alternative embodiment of a field coating system 1300 is substantially identical in design and operation to field coating system 1100 described above with reference to FIGS. 7a, 7b, 7c, 7d, 9, 10, 11a, 11b, 13, 14 and 15, with provision of a plurality of actuators 1302 coupled to the chassis 402 for moving the chassis 402 in direction 502a and direction 502b relative to the support structure 1102.

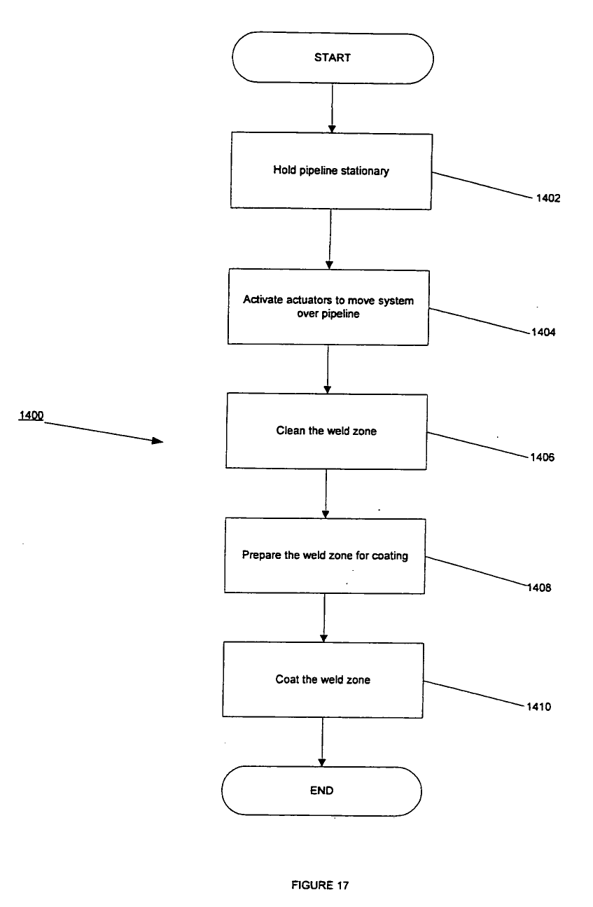

In an exemplary embodiment, during operation of the system 1300, as illustrated in FIGS. 7a, 7b, 7c, 7d, 9, 10, 11a, 11b, 13, 16 and 17, a method 1400 is implemented using the system in which, in step 1402, the pipeline 300 including a plurality of pipeline segments, 302a and 302b, that are coupled end to end by a welded joint 308 in a weld zone 310 is held in a stationary position relative to the support structure 1102. In step 1404, the chassis 402 coupled to cleaning module 802, coating preparation module 404, and coating module 406, is displaces around and over the pipeline, in direction 502b, by activating actuators 1302. In step 1406, the weld zone 310 of the pipeline 300 is cleaned by the cleaning module 802, in step 1408, the weld zone 310 of the pipeline 300 is prepared for coating by the coating preparation module 404, and in step 1410, the weld zone 310 of the pipeline 300 is coated by the coating module 406.

In several exemplary embodiments, one or more of the cleaning module, coating preparation module, and coating module may each include a plurality of cleaning modules, coating preparation modules, and coating modules for performing the cleaning, coating preparation, and coating processes.

A field coating system has been described that includes a chassis and a plurality of modules coupled to the chassis, whereby the plurality of modules are operable to perform a field coating process and define a channel for allowing an entity to move axially through the system, the movement being relative to the system, in order to apply a field coating to the entity. In an exemplary embodiment, the plurality of modules include a cleaning module operable to clean the entity. In an exemplary embodiment, the cleaning module includes a sensor operable to determine the cleanliness of the entity. In an exemplary embodiment, the cleaning module includes a sensor operable to activate and deactivate the cleaning module depending on the position of the entity in the system. In an exemplary embodiment, the plurality of modules include a coating preparation module operable to prepare the entity for coating. In an exemplary embodiment, the coating preparation module includes a sensor operable to determine whether the entity has been properly prepared for coating. In an exemplary embodiment, the coating preparation module includes a sensor operable to activate and deactivate the coating preparation module depending on the position of the entity in the system. In an exemplary embodiment, the plurality of modules includes a coating module operable to coat the entity. In an exemplary embodiment, the coating module includes a sensor operable to determine the quality of the coating applied to the entity. In an exemplary embodiment, the coating module includes a sensor operable to activate and deactivate the coating module depending on the position of the entity in the system. In an exemplary embodiment, at least one module substantially surrounds a perimeter of the entity when the entity moves axially through the system. In an exemplary embodiment, the channel may be opened in order to allow the entity to enter and exit the system, and the channel may be closed in order to secure the entity in the system. In an exemplary embodiment, the entity is a pipeline. In an exemplary embodiment, the field coating process includes fusion bonded epoxy coating. In an exemplary embodiment, the field coating process includes concrete coating. In an exemplary embodiment, the field coating process includes mastic coating.

A field coating system has been described that includes a chassis, a cleaning module coupled to the chassis and operable to clean the entity as it travels through the system, the cleaning module defining a channel for allowing an entity to move axially through the cleaning module, the movement being relative to the cleaning module, a coating preparation module coupled to the chassis and operable to prepare the entity for coating as it travels through the system, the coating preparation module defining a channel for allowing an entity to move axially through the coating preparation module, the movement being relative to the coating preparation module, and a coating module coupled to the chassis and operable to coat the entity as it travels through the system the coating module defining a channel for allowing an entity to move axially through the coating module, the movement being relative to the coating module,. In an exemplary embodiment, the cleaning module includes a sensor operable to determine the cleanliness of the entity. In an exemplary embodiment, the cleaning module includes a sensor operable to activate and deactivate the cleaning module depending on the position of the entity in the system. In an exemplary embodiment, the coating preparation module includes a sensor operable to determine whether the entity has been properly prepared for coating. In an exemplary embodiment, the coating preparation module includes a sensor operable to activate and deactivate the coating preparation module depending on the position of the entity in the system. In an exemplary embodiment, the coating module includes a sensor operable to determine the quality of the coating applied to the entity. In an exemplary embodiment, the coating module includes a sensor operable to activate and deactivate the coating module depending on the position of the entity in the system. In an exemplary embodiment, at least one module substantially surrounds a perimeter of the entity when the entity moves axially through the system. In an exemplary embodiment, the channel may be opened in order to allow the entity to enter and exit the system, and the channel may be closed in order to secure the entity in the system. In an exemplary embodiment, the entity is a pipeline.

A pipelay vessel has been described that includes a construction ramp mounted to the vessel operable to construct pipelines, at least one working station coupled to the vessel, the working station including a chassis, and a plurality of modules coupled to the chassis, the plurality of modules operable to perform a field coating process and defining a channel for allowing a pipeline to move axially through the system, the movement being relative to the system, in order to apply a field coating to the pipeline. In an exemplary embodiment, the plurality of modules include a cleaning module operable to clean the entity. In an exemplary embodiment, the cleaning module includes a sensor operable to determine the cleanliness of the entity. In an exemplary embodiment, the cleaning module includes a sensor operable to activate and deactivate the cleaning module depending on the position of the entity in the system. In an exemplary embodiment, the plurality of modules include a coating preparation module operable to prepare the entity for coating. In an exemplary embodiment, the coating preparation module includes a sensor operable to determine whether the entity has been properly prepared for coating. In an exemplary embodiment, the coating preparation module includes a sensor operable to activate and deactivate the coating preparation module depending on the position of the entity in the system. In an exemplary embodiment, the plurality of modules includes a coating module operable to coat the entity. In an exemplary embodiment, the coating module includes a sensor operable to determine the quality of the coating applied to the entity. In an exemplary embodiment, the coating module includes a sensor operable to activate and deactivate the coating module depending on the position of the entity in the system. In an exemplary embodiment, at least one module substantially surrounds a perimeter of the entity when the entity moves axially through the system. In an exemplary embodiment, the channel may be opened in order to allow the entity to enter and exit to the system, and the channel may be closed in order to secure the entity in the system. In an exemplary embodiment, the entity is a pipeline. In an exemplary embodiment, the field coating process includes fusion bonded epoxy coating. In an exemplary embodiment, the field coating process includes concrete coating. In an exemplary embodiment, the field coating process includes mastic coating.

A method for applying a field coating has been described that includes providing a chassis, coupling a plurality of modules to the chassis, the plurality of modules defining a channel and operable to perform a field coating process, moving an entity axially through the channel, the movement being relative to the chassis, and performing the field coating process on the entity as it travels through the channel. In an exemplary embodiment, the performing includes cleaning the entity as it travels through the channel. In an exemplary embodiment, the performing includes preparing the entity for coating as it travels through the channel. In an exemplary embodiment, the performing includes coating the entity as it travels through the channel.

A method for field coating a pipeline has been described that includes providing a pipelay vessel, mounting at least one working station to the vessel, the working station comprising a chassis and defining a channel, coupling a plurality of modules to the chassis, the plurality of modules operable to perform a field coating process, moving a pipeline axially through the channel, the movement being relative to the chassis, and performing the field coating process on the pipeline as it travels through the channel. In an exemplary embodiment, the performing includes cleaning the pipeline as it travels through the channel. In an exemplary embodiment, the performing includes preparing the pipeline for coating as it travels through the channel. In an exemplary embodiment, the performing includes coating the pipeline as it travels through the channel.

A field coating system has been described that includes a chassis, a means coupled to the chassis for allowing an entity to move axially through the system, the movement being relative to the system, a means coupled to the chassis for preparing the entity for coating as it travels through the system, and a means coupled to the chassis for coating the entity as it travels through the system. In an exemplary embodiment, the system further includes a means coupled to the chassis for cleaning the entity as it travels through the system. In an exemplary embodiment, the means coupled to the chassis for cleaning the entity includes a means for determining the cleanliness of the entity. In an exemplary embodiment, the means coupled to the chassis for cleaning the entity includes a means for activating and deactivating the means coupled to the chassis for cleaning the entity depending on the position of the entity in the system. In an exemplary embodiment, the means coupled to the chassis for preparing the entity for coating includes a means for determining whether the entity has been properly prepared for coating. In an exemplary embodiment, the means coupled to the chassis for preparing the entity for coating includes a means for activating and deactivating the means coupled to the chassis for preparing the entity for coating depending on the position of the entity in the system. In an exemplary embodiment, the means coupled to the chassis for coating the entity includes a means for determining the quality of the coating applied to the entity. In an exemplary embodiment, the means coupled to the chassis for coating the entity includes a means for activating and deactivating the means coupled to the chassis for coating the entity depending on the position of the entity in the system. In an exemplary embodiment, at least a portion of the means coupled to the chassis for allowing an entity to move axially through the system substantially surrounds a perimeter of the entity when the entity moves axially through the system. In an exemplary embodiment, the means coupled to the chassis for allowing an entity to move axially through the system may be opened in order to allow the entity to enter and exit the system, and the means coupled to the chassis for allowing an entity to move axially through the system may be closed in order to secure the entity in the system. In an exemplary embodiment, the entity is a pipeline.

A field coating system has been described that includes a chassis, a cleaning module coupled to the chassis operable to clean the entity as it travels through the system, the cleaning module defining a channel for allowing an entity to move axially through the cleaning module, the movement being relative to the cleaning module, a first sensor coupled to the cleaning module operable to determine the cleanliness of the entity, a second sensor coupled to the cleaning module operable to activate and deactivate the cleaning module depending on the position of the entity in the system, a coating preparation module coupled to the chassis operable to prepare the entity for coating as it travels through the system, the coating preparation module defining a channel for allowing an entity to move axially through the coating preparation module, the movement being relative to the coating preparation module, a third sensor coupled to the coating preparation module operable to determine whether the entity has been properly prepared for coating, a fourth sensor coupled to the coating preparation module operable to activate and deactivate the coating preparation module depending on the position of the entity in the system, a coating module coupled to the chassis operable to coat the entity as it travels through the system, the coating module defining a channel for allowing an entity to move axially through the coating module, the movement being relative to the coating module, a fifth sensor coupled to the coating module operable to determine the quality of the coating applied to the entity, and a sixth sensor coupled to the coating module operable to activate and deactivate the coating module depending on the position of the entity in the system. In an exemplary embodiment, at least one module substantially surrounds a perimeter of the entity when the entity moves axially through the system. In an exemplary embodiment, the channel may be opened in order to allow the entity to enter and exit the system, and the channel may be closed in order to secure the entity in the system. In an exemplary embodiment, the entity is a pipeline.

A field coating system has been described that includes a chassis. A coating preparation module is coupled to the chassis, the coating preparation module including a first housing, the first housing defining a channel for allowing the entity to move axially through the coating preparation module, the movement being relative to the coating preparation module, at least one section on the first housing moveably mounted to the first housing on hinges, a coating preparation apparatus with coating preparation elements situated within the first housing and operable to prepare an entity for coating as it travels through the system, at least one section on the coating preparation apparatus moveably mounted to the coating preparation apparatus on hinges, a first sensor situated within the first housing operable to determine whether the entity has been prepared for coating, a second sensor situated within the first housing operable to activate and deactivate the coating preparation module depending on the position of the entity in the system, and a plurality of seals mounted to the first housing operable to seal and isolate a portion of the entity in the first housing. A coating module is coupled to the chassis, the coating module including a second housing, the second housing defining a channel for allowing an entity to move axially through the coating module, the movement being relative to the coating module, at least one section on the second housing moveably mounted to the second housing on hinges, a coating apparatus with coating elements situated within the second housing and operable to coat the entity as it travels through the system, at least one section on the coating apparatus moveably mounted to the coating apparatus on hinges, a third sensor situated within the second housing operable to determine the quality of the coating applied to the entity, a fourth sensor situated within the second housing operable to activate and deactivate the coating module depending on the position of the entity in the system, and a plurality of seals mounted to the second housing for sealing and isolating a portion of the entity in the second housing.

A method for field coating a pipeline has been described that includes providing a pipeline, the pipeline including a weld zone, providing a field coating system, the system including a coating preparation module and a coating module, moving the weld zone axially through the system, detecting the weld zone entering the coating preparation module, activating the coating preparation module, detecting the weld zone exiting the coating preparation module, deactivating the coating preparation module, determining the weld zone is prepared for coating, detecting the weld zone entering the coating module, activating the coating module, detecting the weld zone exiting the coating module, deactivating the coating module, and determining the weld zone is coated.

A field coating system has been described that includes a chassis. A cleaning module is coupled to the chassis, the cleaning module including a first housing, the first housing defining a channel for allowing the entity to move axially through the cleaning module, the movement being relative to the cleaning module, at least one section on the first housing moveably mounted to the first housing on hinges, a cleaning apparatus with cleaning elements situated within the first housing and operable to clean an entity as it travels through the system, at least one section on the cleaning apparatus moveably mounted to the cleaning apparatus on hinges, a first sensor situated within the first housing operable to determine the cleanliness of the entity, a second sensor situated within the first housing operable to activate and deactivate the cleaning module depending on the position of the entity in the system, and a plurality of seals mounted to the first housing operable to seal and isolate a portion of the entity in the first housing. A coating preparation module is coupled to the chassis, the coating preparation module including a second housing, the second housing defining a channel for allowing the entity to move axially through the coating preparation module, the movement being relative to the coating preparation module, at least one section on the second housing moveably mounted to the second housing on hinges, a coating preparation apparatus with coating preparation elements situated within the second housing and operable to prepare the entity for coating as it travels through the system, at least one section on the s coating preparation apparatus moveably mounted to the coating preparation apparatus on hinges, a third sensor situated within the second housing operable to determine whether the entity has been properly prepared for coating, a fourth sensor situated within the second housing operable to activate and deactivate the coating preparation module depending on the position of the entity in the system, and a plurality of seals mounted to the second housing for sealing and isolating a portion of the entity in the second housing. A coating module is coupled to the chassis, the coating module including a third housing, the third housing defining a channel for allowing an entity to move axially through the coating module, the movement being relative to the coating module, at least one section on the third housing moveably mounted to the third housing on hinges, a coating apparatus with coating elements situated within the third housing and operable to coat the entity as it travels through the system, at least one section on the coating apparatus moveably mounted to the coating apparatus on hinges, a fifth sensor situated within the third housing operable to determine the quality of the coating applied to the entity, a sixth sensor situated within the third housing operable to activate and deactivate the coating module depending on the position of the entity in the system, and a plurality of seals mounted to the third housing for sealing and isolating a portion of the entity in the third housing.

A method for field coating a pipeline has been described that includes providing a pipeline, the pipeline including a weld zone, providing a field coating system, the system including a cleaning module, a coating preparation module, and a coating module, moving the weld zone axially through the system, detecting the weld zone entering the cleaning module, activating the cleaning module, detecting the weld zone exiting the cleaning module, deactivating the cleaning module, determining the weld zone is clean, detecting the weld zone entering the coating preparation module, activating the coating preparation module, detecting the weld zone exiting the coating preparation module, deactivating the coating preparation module, determining the weld zone is prepared for coating, detecting the weld zone entering the coating module. activating the coating module, detecting the weld zone exiting the coating module, deactivating the coating module, and determining the weld zone is coated.

A field coating system has been described that includes a chassis that is moveably mounted to a support structure. A cleaning module is coupled to the chassis, the cleaning module including a first housing, the first housing defining a channel for allowing the entity to move axially through the cleaning module, the movement being relative to the cleaning module, at least one section on the first housing moveably mounted to the first housing on hinges, a cleaning apparatus with cleaning elements situated within the first housing and operable to clean an entity as it travels through the system, at least one section on the cleaning apparatus moveably mounted to the cleaning apparatus on hinges, a first sensor situated within the first housing operable to determine the cleanliness of the entity, a second sensor situated within the first housing operable to activate and deactivate the cleaning module depending on the position of the entity in the system, and a plurality of seals mounted to the first housing operable to seal and isolate a portion of the entity in the first housing. A coating preparation module is coupled to the chassis, the coating preparation module comprising a second housing, the second housing defining a channel for allowing the entity to move axially through the coating preparation module, the movement being relative to the coating preparation module, at least one section on the second housing moveably mounted to the second housing on hinges, a coating preparation apparatus with coating preparation elements situated within the second housing and operable to prepare the entity for coating as it travels through the system, at least one section on the coating preparation apparatus moveably mounted to the coating preparation apparatus on hinges, a third sensor situated within the second housing operable to determine whether the entity has been properly prepared for coating, a fourth sensor situated within the second housing operable to activate and deactivate the coating preparation module depending on the position of the entity in the system, and a plurality of seals mounted to the second housing for sealing and isolating a portion of the entity in the second housing. A coating module is coupled to the chassis, the coating module comprising a third housing, the third housing defining a channel for allowing an entity to move axially through the coating module, the movement being relative to the coating module, at least one section on the third housing moveably mounted to the third housing on hinges, a coating apparatus with coating elements situated within the third housing and operable to coat the entity as it travels through the system, at least one section on the coating apparatus moveably mounted to the coating apparatus on hinges, a fifth sensor situated within the third housing operable to determine the quality of the coating applied to the entity, a sixth sensor situated within the third housing operable to activate and deactivate the coating module depending on the position of the entity in the system, and a plurality of seals mounted to the third housing for sealing and isolating a portion of the entity in the third housing.

A field coating system has been described that includes a chassis which is moveably mounted to a support structure with at least one actuator coupled to the chassis, the at least one actuator operable to move the chassis. A cleaning module is coupled to the chassis, the cleaning module comprising a first housing, the first housing defining a channel for allowing the entity to move axially through the cleaning module, the movement being relative to the cleaning module, at least one section on the first housing moveably mounted to the first housing on hinges, a cleaning apparatus with cleaning elements situated within the first housing and operable to clean an entity as it travels through the system, at least one section on the cleaning apparatus moveably mounted to the cleaning apparatus on hinges, a first sensor situated within the first housing operable to determine the cleanliness of the entity, a second sensor situated within the first housing operable to activate and deactivate the cleaning module depending on the position of the entity in the system, and a plurality of seals mounted to the first housing operable to seal and isolate a portion of the entity in the first housing. A coating preparation is module coupled to the chassis, the coating preparation module comprising a second housing, the second housing defining a channel for allowing the entity to move axially through the coating preparation module, the movement being relative to the coating preparation module, at least one section on the second housing moveably mounted to the second housing on hinges, a coating preparation apparatus with coating preparation elements situated within the second housing and operable to prepare the entity for coating as it travels through the system, at least one section on the coating preparation apparatus moveably mounted to the coating preparation apparatus on hinges, a third sensor situated within the second housing operable to determine whether the entity has been properly prepared for coating, a fourth sensor situated within the second housing operable to activate and deactivate the coating preparation module depending on the position of the entity in the system, and a plurality of seals mounted to the second housing for sealing and isolating a portion of the entity in the second housing. A coating module is coupled to the chassis, the coating module comprising a third housing, the third housing defining a channel for allowing an entity to move axially through the coating module, the movement being relative to the coating module, at least one section on the third housing moveably mounted to the third housing on hinges, a coating apparatus with coating elements situated within the third housing and operable to coat the entity as it travels through the system, at least one section on the coating apparatus moveably mounted to the coating apparatus on hinges, a fifth sensor situated within the third housing operable to determine the quality of the coating applied to the entity, a sixth sensor situated within the third housing operable to activate and deactivate the coating module depending on the position of the entity in the system, and a plurality of seals mounted to the third housing for sealing and isolating a portion of the entity in the third housing.

A method for field coating a pipeline has been described that includes providing a pipeline, the pipeline including a weld zone, providing a support structure, providing a field coating system, the system including a cleaning module, a coating preparation module, and a coating module, coupled to a chassis, the chassis moveably mounted on the support structure, holding the pipeline in a stationary position, moving the field coating system over the weld zone, detecting the cleaning module entering the weld zone, activating the cleaning module, detecting the cleaning module exiting the weld zone, deactivating the cleaning module, determining the weld zone is clean, detecting the coating preparation module entering the weld zone, activating the coating preparation module, detecting the coating preparation module exiting the weld zone, deactivating the coating preparation module, determining the weld zone is prepared for coating, detecting the coating module entering the weld zone, activating the coating module, detecting the coating module exiting the weld zone, deactivating the coating module, and determining the weld zone is coated.

A method for field coating a pipeline has been described that includes providing a pipeline, the pipeline including a weld zone, providing a support structure, providing a field coating system, the system including a cleaning module, a coating preparation module, and a coating module, coupled to a chassis, the chassis moveably mounted on the support structure, coupling at least one actuator to the chassis, the at least one actuator operable to move the chassis, holding the pipeline in a stationary position, activating the actuator to move the field coating system over the weld zone, detecting the cleaning module entering the weld zone, activating the cleaning module, detecting the cleaning module exiting the weld zone, deactivating the cleaning module, determining the weld zone is clean, detecting the coating preparation module entering the weld zone, activating the coating preparation module, detecting the coating preparation module exiting the weld zone, deactivating the coating preparation module, determining the weld zone is prepared for coating, detecting the coating module entering the weld zone, activating the coating module, detecting the coating module exiting the weld zone, deactivating the coating module, and determining the weld zone is coated.

It is understood that variations may be made in the foregoing without departing from the scope of the invention. Furthermore, the elements and teachings of the various illustrative embodiments may be combined in whole or in part some or all of the illustrative embodiments.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A field coating system comprising:
a chassis; and
a plurality of modules coupled to the chassis, the plurality of modules operable to perform a field coating process and defining a channel for allowing an entity to move axially through the system, the movement being relative to the system, in order to apply a field coating to the entity.

2. The system of claim 1 wherein the plurality of modules comprise a cleaning module operable to clean the entity.

3. The system of claim 2 wherein the cleaning module comprises a sensor operable to determine the cleanliness of the entity.

4. The system of claim 2 wherein the cleaning module comprises a sensor operable to activate and deactivate the cleaning module depending on the position of the entity in the system.

5. The system of claim 1 wherein the plurality of modules comprise a coating preparation module operable to prepare the entity for coating.

6. The system of claim 5 wherein the coating preparation module comprises a sensor operable to determine whether the entity has been properly prepared for coating.

7. The system of claim 5 wherein the coating preparation module comprises a sensor operable to activate and deactivate the coating preparation module depending on the position of the entity in the system.

8. The system of claim 1 wherein the plurality of modules comprises a coating module operable to coat the entity.

9. The system of claim 8 wherein the coating module comprises a sensor operable to determine the quality of the coating applied to the entity.

10. The system of claim 8 wherein the coating module comprises a sensor operable to activate and deactivate the coating module depending on the position of the entity in the system.

11. The system of claim 1 wherein at least one module substantially surrounds a perimeter of the entity when the entity moves axially through the system.

12. The system of claim 1 wherein the channel may be opened in order to allow the entity to enter and exit the system, and the channel may be closed in order to secure the entity in the system.

13. The system of claim 1 wherein the entity comprises a pipeline.

14. The system of claim 1 wherein the field coating process comprises fusion bonded epoxy coating.

15. The system of claim 1 wherein the field coating process comprises concrete coating.

16. The system of claim 1 wherein the field coating process comprises mastic coating.

17. The system of claim 1 wherein the system is positioned on a pipelay vessel.

18. The system of claim 1 wherein the system is positioned on land.

19. A field coating system comprising:
a chassis;
a cleaning module coupled to the chassis operable to clean the entity as it travels through the system, the cleaning module defining a channel for allowing an entity to move axially through the cleaning module, the movement being relative to the cleaning module;
a coating preparation module coupled to the chassis operable to prepare the entity for coating as it travels through the system, the coating preparation module defining a channel for allowing an entity to move axially through the coating preparation module, the movement being relative to the coating preparation module; and
a coating module coupled to the chassis operable to coat the entity as it travels through the system, the coating module defining a channel for allowing an entity to move axially through the coating module, the movement being relative to the coating module.

20. The system of claim 19 wherein the cleaning module comprises a sensor operable to determine the cleanliness of the entity.

21. The system of claim 19 wherein the cleaning module comprises a sensor operable to activate and deactivate the cleaning module depending on the position of the entity in the system.

22. The system of claim 19 wherein the coating preparation module comprises a sensor operable to determine whether the entity has been properly prepared for coating.

23. The system of claim 19 wherein the coating preparation module comprises a sensor operable to activate and deactivate the coating preparation module depending on the position of the entity in the system.

24. The system of claim 19 wherein the coating module comprises a sensor operable to determine the quality of the coating applied to the entity.

25. The system of claim 19 wherein the coating module comprises a sensor operable to activate and deactivate the coating module depending on the position of the entity in the system.

26. The system of claim 19 wherein at least one module substantially surrounds a perimeter of the entity when the entity moves axially through the system.

27. The system of claim 19 wherein the channel may be opened in order to allow the entity to enter and exit the system, and the channel may be closed in order to secure the entity in the system.

28. The system of claim 19 wherein the entity comprises a pipeline.

29. The system of claim 19 wherein the system is positioned on a pipelay vessel.

30. The system of claim 19 wherein the system is positioned on land.

31. A pipelay vessel comprising:
a construction ramp mounted to the vessel operable to construct pipelines;
at least one working station coupled to the vessel, the working station comprising a chassis; and
a plurality of modules coupled to the chassis, the plurality of modules operable to perform a field coating process and defining a channel for allowing a pipeline to move axially through the system, the movement being relative to the system, in order to apply a field coating to the pipeline.

32. The vessel of claim 31 wherein the plurality of modules comprise a cleaning module operable to clean the entity.

33. The vessel of claim 32 wherein the cleaning module comprises a sensor operable to determine the cleanliness of the entity.

34. The vessel of claim 32 wherein the cleaning module comprises a sensor operable to activate and deactivate the cleaning module depending on the position of the entity in the system.

35. The vessel of claim 31 wherein the plurality of modules comprise a coating preparation module operable to prepare the entity for coating.

36. The vessel of claim 35 wherein the coating preparation module comprises a sensor operable to determine whether the entity has been properly prepared for coating.

37. The vessel of claim 35 wherein the coating preparation module comprises a sensor operable to activate and deactivate the coating preparation module depending on the position of the entity in the system.

38. The vessel of claim 31 wherein the plurality of modules comprises a coating module operable to coat the entity.

39. The vessel of claim 38 wherein the coating module comprises a sensor operable to determine the quality of the coating applied to the entity.

40. The vessel of claim 38 wherein the coating module comprises a sensor operable to activate and deactivate the coating module depending on the position of the entity in the system.

41. The vessel of claim 31 wherein at least one module substantially surrounds a perimeter of the entity when the entity moves axially through the system.

42. The vessel of claim 31 wherein the channel may be opened in order to allow the entity to enter and exit to the system, and the channel may be closed in order to secure the entity in the system.

43. The vessel of claim 31 wherein the entity comprises a pipeline.

44. The vessel of claim 31 wherein the field coating process comprises fusion bonded epoxy coating.

45. The vessel of claim 31 wherein the field coating process comprises concrete coating.

46. The vessel of claim 31 wherein the field coating process comprises mastic coating.

47. A method for applying a field coating comprising:
providing a chassis;
coupling a plurality of modules to the chassis, the plurality of modules defining a channel and operable to perform a field coating process;
moving an entity axially through the channel, the movement being relative to the plurality of modules; and
performing the field coating process on the entity as it travels through the channel.

48. The method of claim 47 wherein the performing comprises cleaning the entity as it travels through the channel.

49. The method of claim 47 wherein the performing comprises preparing the entity for coating as it travels through the channel.

50. The method of claim 47 wherein the performing comprises coating the entity as it travels through the channel.

51. The method of claim 47 wherein the method is positioned on a pipelay vessel.

52. The method of claim 47 wherein the method is positioned on land.

53. A method of field coating a pipeline comprising:
providing a pipelay vessel;
mounting at least one working station to the vessel, the working station comprising a chassis and defining a channel;
coupling a plurality of modules to the chassis, the plurality of modules operable to perform a field coating process;
moving a pipeline axially through the channel, the movement being relative to the chassis; and
performing the field coating process on the pipeline as it travels through the channel.

54. The method of claim 53 wherein the performing comprises cleaning the pipeline as it travels through the channel.

55. The method of claim 53 wherein the performing comprises preparing the pipeline for coating as it travels through the channel.

56. The method of claim 53 wherein the performing comprises coating the pipeline as it travels through the channel.

57. A field coating system comprising:
a chassis;
a means coupled to the chassis for allowing an entity to move axially through the system, the movement being relative to the system;
a means coupled to the chassis for preparing the entity for coating as it travels through the system; and
a means coupled to the chassis for coating the entity as it travels through the system.

58. The system of claim 57 further comprising:
a means coupled to the chassis for cleaning the entity as it travels through the system.

59. The system of claim 58 wherein the means coupled to the chassis for cleaning the entity comprises a means for determining the cleanliness of the entity.

60. The system of claim 58 wherein the means coupled to the chassis for cleaning the entity comprises a means for activating and deactivating the means coupled to the chassis for cleaning the entity depending on the position of the entity in the system.

61. The system of claim 57 wherein the means coupled to the chassis for preparing the entity for coating comprises a means for determining whether the entity has been properly prepared for coating.

62. The system of claim 57 wherein the means coupled to the chassis for preparing the entity for coating comprises a means for activating and deactivating the means coupled to the chassis for preparing the entity for coating depending on the position of the entity in the system.

63. The system of claim 57 wherein the means coupled to the chassis for coating the entity comprises a means for determining the quality of the coating applied to the entity.

64. The system of claim 57 wherein the means coupled to the chassis for coating the entity comprises a means for activating and deactivating the means coupled to the chassis for coating the entity depending on the position of the entity in the system.

65. The system of claim 57 wherein at least a portion of the means coupled to the chassis for allowing an entity to move axially through the system substantially surrounds a perimeter of the entity when the entity moves axially through the system.

66. The system of claim 57 wherein the means coupled to the chassis for allowing an entity to move axially through the system may be opened in order to allow the entity to enter and exit the system, and the means coupled to the chassis for allowing an entity to move axially through the system may be closed in order to secure the entity in the system.

67. The system of claim 57 wherein the entity comprises a pipeline.

68. The system of claim 57 wherein the system is positioned on a pipelay vessel.

69. The system of claim 57 wherein the system is positioned on land.

70. A field coating system comprising:
a chassis;
a cleaning module coupled to the chassis operable to clean the entity as it travels through the system, the cleaning module defining a channel for allowing an entity to move axially through the cleaning module, the movement being relative to the cleaning module;
a first sensor coupled to the cleaning module operable to determine the cleanliness of the entity;
a second sensor coupled to the cleaning module operable to activate and deactivate the cleaning module depending on the position of the entity in the system;
a coating preparation module coupled to the chassis operable to prepare the entity for coating as it travels through the system, the coating preparation module defining a channel for allowing an entity to move axially through the coating preparation module, the movement being relative to the coating preparation module;
a third sensor coupled to the coating preparation module operable to determine whether the entity has been properly prepared for coating;
a fourth sensor coupled to the coating preparation module operable to activate and deactivate the coating preparation module depending on the position of the entity in the system;
a coating module coupled to the chassis operable to coat the entity as it travels through the system, the coating module defining a channel for allowing an entity to move axially through the coating module, the movement being relative to the coating module;
a fifth sensor coupled to the coating module operable to determine the quality of the coating applied to the entity; and
a sixth sensor coupled to the coating module operable to activate and deactivate the coating module depending on the position of the entity in the system.

71. The system of claim 70 wherein at least one module substantially surrounds a perimeter of the entity when the entity moves axially through the system.

72. The system of claim 70 wherein the channel may be opened in order to allow the entity to enter and exit the system, and the channel may be closed in order to secure the entity in the system.

73. The system of claim 70 wherein the entity comprises a pipeline.

74. The system of claim 70 wherein the system is positioned on a pipelay vessel.

75. The system of claim 70 wherein the system is positioned on land.

76. A field coating system comprising:
a chassis;
a coating preparation module coupled to the chassis, the coating preparation module comprising a first housing, the first housing defining a channel for allowing an entity to move axially through the coating preparation module, the movement being relative to the coating preparation module;
at least one section on the first housing moveably mounted to the first housing on hinges;
a coating preparation apparatus with coating preparation elements situated within the first housing and operable to prepare the entity for coating as it travels through the system;
at least one section on the coating preparation apparatus moveably mounted to the coating preparation apparatus on hinges;
a first sensor situated within the first housing operable to determine whether the entity has been properly prepared for coating;
a second sensor situated within the first housing operable to activate and deactivate the coating preparation module depending on the position of the entity in the system;
a plurality of seals mounted to-the first housing operable to seal and isolate a portion of the entity in the first housing;
a coating module coupled to the chassis, the coating module comprising a second housing, the second housing defining a channel for allowing the entity to move axially through the coating module, the movement being relative to the coating module;
at least one section on the second housing moveably mounted to the second housing on hinges;
a coating apparatus with coating elements situated within the second housing and operable to coat the entity as it travels through the system;
at least one section on the coating apparatus moveably mounted to the coating apparatus on hinges;
a third sensor situated within the second housing operable to determine the quality of the coating applied to the entity;
a fourth sensor situated within the second housing operable to activate and deactivate the coating module depending on the position of the entity in the system; and
a plurality of seals mounted to the second housing for sealing and isolating a portion of the entity in the second housing.

77. A method for field coating a pipeline comprising:
providing a pipeline, the pipeline comprising a weld zone;
providing a field coating system, the system comprising a coating preparation module and a coating module;
moving the weld zone axially through the system;
detecting the weld zone entering the coating preparation module;
activating the coating preparation module;
detecting the weld zone exiting the coating preparation module;
deactivating the coating preparation module;
determining the weld zone is prepared for coating;
detecting the weld zone entering the coating module;
activating the coating module;
detecting the weld zone exiting the coating module;
deactivating the coating module; and
determining the weld zone is coated.

78. A field coating system comprising:
a chassis;
a cleaning module coupled to the chassis, the cleaning module comprising a first housing, the first housing defining a channel for allowing an entity to move axially through the cleaning module, the movement being relative to the cleaning module;
at least one section on the first housing moveably mounted to the first housing on hinges;
a cleaning apparatus with cleaning elements situated within the first housing and operable to clean the entity as it travels through the system;
at least one section on the cleaning apparatus moveably mounted to the cleaning apparatus on hinges;
a first sensor situated within the first housing operable to determine the cleanliness of the entity;
a second sensor situated within the first housing operable to activate and deactivate the cleaning module depending on the position of the entity in the system;
a plurality of seals mounted to the first housing operable to seal and isolate a portion of the entity in the first housing;
a coating preparation module coupled to the chassis, the coating preparation module comprising a second housing, the second housing defining a channel for allowing the entity to move axially through the coating preparation module, the movement being relative to the coating preparation module;
at least one section on the second housing moveably mounted to the second housing on hinges;
a coating preparation apparatus with coating preparation elements situated within the second housing and operable to prepare the entity for coating as it travels through the system,
at least one section on the coating preparation apparatus moveably mounted to the coating preparation apparatus on hinges;
a third sensor situated within the second housing operable to determine whether the entity has been properly prepared for coating;
a fourth sensor situated within the second housing operable to activate and deactivate the coating preparation module depending on the position of the entity in the system;
a plurality of seals mounted to the second housing for sealing and isolating a portion of the entity in the second housing;
a coating module coupled to the chassis, the coating module comprising a third housing, the third housing defining a channel for allowing the entity to move axially through the coating module, the movement being relative to the coating module;
at least one section on the third housing moveably mounted to the third housing on hinges;
a coating apparatus with coating elements situated within the third housing and operable to coat the entity as it travels through the system;
at least one section on the coating apparatus moveably mounted to the coating apparatus on hinges;
a fifth sensor situated within the third housing operable to determine the quality of the coating applied to the entity;
a sixth sensor situated within the third housing operable to activate and deactivate the coating module depending on the position of the entity in the system; and
a plurality of seals mounted to the third housing for sealing and isolating a portion of the entity in the third housing.

79. A method for field coating a pipeline comprising:
providing a pipeline, the pipeline comprising a weld zone;
providing a field coating system, the system comprising a cleaning module, a coating preparation module, and a coating module;
moving the weld zone axially through the system;
detecting the weld zone entering the cleaning module;
activating the cleaning module;
detecting the weld zone exiting the cleaning module;
deactivating the cleaning module;
determining the weld zone is clean;
detecting the weld zone entering the coating preparation module;
activating the coating preparation module;
detecting the weld zone exiting the coating preparation module;
deactivating the coating preparation module;
determining the weld zone is prepared for coating;
detecting the weld zone entering the coating module;
activating the coating module;
detecting the weld zone exiting the coating module;
deactivating the coating module; and
determining the weld zone is coated.

80. A field coating system comprising:
a chassis, the chassis moveably mounted to a support structure;
a cleaning module coupled to the chassis, the cleaning module comprising a first housing, the first housing defining a channel for allowing the entity to move axially through the cleaning module, the movement being relative to the cleaning module;
at least one section on the first housing moveably mounted to the first housing on hinges;
a cleaning apparatus with cleaning elements situated within the first housing and operable to clean an entity as it travels through the system;
at least one section on the cleaning apparatus moveably mounted to the cleaning apparatus on hinges;
a first sensor situated within the first housing operable to determine the cleanliness of the entity;
a second sensor situated within the first housing operable to activate and deactivate the cleaning module depending on the position of the entity in the system;
a plurality of seals mounted to the first housing operable to seal and isolate a portion of the entity in the first housing;
a coating preparation module coupled to the chassis, the coating preparation module comprising a second housing, the second housing defining a channel for allowing the entity to move axially through the coating preparation module, the movement being relative to the coating preparation module;
at least one section on the second housing moveably mounted to the second housing on hinges;
a coating preparation apparatus with coating preparation elements situated within the second housing and operable to prepare the entity for coating as it travels through the system;
at least one section on the coating preparation apparatus moveably mounted to the coating preparation apparatus on hinges;
a third sensor situated within the second housing operable to determine whether the entity has been properly prepared for coating;
a fourth sensor situated within the second housing operable to activate and deactivate the coating preparation module depending on the position of the entity in the system;
a plurality of seals mounted to the second housing for sealing and isolating a portion of the entity in the second housing;
a coating module coupled to the chassis, the coating module comprising a third housing, the third housing defining a channel for allowing an entity to move axially through the coating module, the movement being relative to the coating module;
at least one section on the third housing moveably mounted to the third housing on hinges;
a coating apparatus with coating elements situated within the third housing and operable to coat the entity as it travels through the system;
at least one section on the coating apparatus moveably mounted to the coating apparatus on hinges;
a fifth sensor situated within the third housing operable to determine the quality of the coating applied to the entity;
a sixth sensor situated within the third housing operable to activate and deactivate the coating module depending on the position of the entity in the system; and
a plurality of seals mounted to the third housing for sealing and isolating a portion of the entity in the third housing.

81. A field coating system comprising:
a chassis, the chassis moveably mounted to a support structure;
at least one actuator coupled to the chassis, the at least one actuator operable to move the chassis;
a cleaning module coupled to the chassis, the cleaning module comprising a first housing, the first housing defining a channel for allowing the entity to move axially through the cleaning module, the movement being relative to the cleaning module;
at least one section on the first housing moveably mounted to the first housing on hinges;
a cleaning apparatus with cleaning elements situated within the first housing and operable to clean an entity as it travels through the system;
at least one section on the cleaning apparatus moveably mounted to the cleaning apparatus on hinges;
a first sensor situated within the first housing operable to determine the cleanliness of the entity;
a second sensor situated within the first housing operable to activate and deactivate the cleaning module depending on the position of the entity in the system;
a plurality of seals mounted to the first housing operable to seal and isolate a portion of the entity in the first housing;
a coating preparation module coupled to the chassis, the coating preparation module comprising a second housing, the second housing defining a channel for allowing the entity to move axially through the coating preparation module, the movement being relative to the coating preparation module;
at least one section on the second housing moveably mounted to the second housing on hinges;
a coating preparation apparatus with coating preparation elements situated within the second housing and operable to prepare the entity for coating as it travels through the system;
at least one section on the coating preparation apparatus moveably mounted to the coating preparation apparatus on hinges;
a third sensor situated within the second housing operable to determine whether the entity has been properly prepared for coating;
a fourth sensor situated within the second housing operable to activate and deactivate the coating preparation module depending on the position of the entity in the system;
a plurality of seals mounted to the second housing for sealing and isolating a portion of the entity in the second housing;
a coating module coupled to the chassis, the coating module comprising a third housing, the third housing defining a channel for allowing an entity to move axially through the coating module, the movement being relative to the coating module;
at least one section on the third housing moveably mounted to the third housing on hinges;
a coating apparatus with coating elements situated within the third housing and operable to coat the entity as it travels through the system;
at least one section on the coating apparatus moveably mounted to the coating apparatus on hinges;
a fifth sensor situated within the third housing operable to determine the quality of the coating applied to the entity;
a sixth sensor situated within the third housing operable to activate and deactivate the coating module depending on the position of the entity in the system; and
a plurality of seals mounted to the third housing for sealing and isolating a portion of the entity in the third housing.

82. A method for field coating a pipeline comprising:
providing a pipeline, the pipeline comprising a weld zone;
providing a support structure;
providing a field coating system, the system comprising a cleaning module, a coating preparation module, and a coating module, coupled to a chassis, the chassis moveably mounted on the support structure;
holding the pipeline in a stationary position;
moving the field coating system over the weld zone;
detecting the cleaning module entering the weld zone;
activating the cleaning module;
detecting the cleaning module exiting the weld zone;
deactivating the cleaning module;
determining the weld zone is clean;
detecting the coating preparation module entering the weld zone;
activating the coating preparation module;
detecting the coating preparation module exiting the weld zone;
deactivating the coating preparation module;
determining the weld zone is prepared for coating;
detecting the coating module entering the weld zone;
activating the coating module;
detecting the coating module exiting the weld zone;
deactivating the coating module; and
determining the weld zone is coated.

83. A method for field coating a pipeline comprising:
providing a pipeline, the pipeline comprising a weld zone;
providing a support structure;
providing a field coating system, the system comprising a cleaning module, a coating preparation module, and a coating module, coupled to a chassis, the chassis moveably mounted on the support structure;
coupling at least one actuator to the chassis, the at least one actuator operable to move the chassis;
holding the pipeline in a stationary position;
activating the actuator to move the field coating system over the weld zone;
detecting the cleaning module entering the weld zone;
activating the cleaning module;
detecting the cleaning module exiting the weld zone;
deactivating the cleaning module;
determining the weld zone is clean;
detecting the coating preparation module entering the weld zone;
activating the coating preparation module;
detecting the coating preparation module exiting the weld zone;
deactivating the coating preparation module;
determining the weld zone is prepared for coating;
detecting the coating module entering the weld zone;
activating the coating module;
detecting the coating module exiting the weld zone;
deactivating the coating module; and
determining the weld zone is coated.
